(19) United States
(12) Patent Application Publication
(10) Pub. No.: US 2022/0400365 A1
(43) Pub. Date: Dec. 15, 2022

(54) AD HOC FILE AND LINK SHARING FOR NEARBY MOBILE DEVICES

(71) Applicant: Arctec Mobile Inc., Vancouver (CA)

(72) Inventor: Inderjit Bains, Vancouver (CA)

(73) Assignee: Arctec Mobile Inc., Vancouver, BC (CA)

(21) Appl. No.: 17/607,391

(22) PCT Filed: Apr. 28, 2020
(86) PCT No.: PCT/CA2020/050560

§ 371 Date: Oct. 28, 2021

Related U.S. Application Data
(60) Provisional application No. 62/840,367, filed on Apr. 29, 2019.

(51) Int. Cl. H04W 4/80; H04W 4/02

(52) U.S. Cl. CPC H04W 4/80; H04W 4/02

(57) ABSTRACT

Systems, methods and techniques are disclosed for ad hoc file, selected/highlighted section and link sharing for gatherings, presentations, meetings, classes, lectures, trade shows, conferences, proximity marketing, ad hoc messaging, and broadcast, cable and streaming shows. In some embodiments, a system may be comprised of a Computing Device, one or more Mobile Devices and a Remote Server. An application, the Share App, on the Computing Device may be used to upload a First Package of Data comprised of a file, selected/highlighted section or link to the Remote Server over an Internet/network connection, and share the First Package of Data with one or more Mobile Devices by transmitting Bluetooth Low Energy Advertisements with a Unique ID, which may be received by the Mobile Devices and may be used by the Share App on the Mobile Devices to download and display the First Package of Data from the Remote Server.

### TECHNICAL FIELD

The present disclosure relates to file, selected/highlighted section and link sharing in ad hoc networks for nearby mobile devices, using Bluetooth Low Energy advertisements and in some embodiments, WiFi beacon frames.

### BACKGROUND

When giving a presentation or lecture, it is sometimes desirable to send a file, selected/highlighted section or link to mobile devices carried by the audience. This normally involves compiling the email addresses of the audience into a list and sending a mass email to the list with the file, selected/highlighted section or link as an attachment, compiling the mobile phone numbers of the audience members into a group of contacts and sending the file, selected/highlighted section to the group using a smartphone app, or having the audience members manually type out the location of the file, the location of selected/highlighted section saved as a file, or the link on a virtual or real keypad on their mobile devices, all of which are cumbersome, error-prone and may present security risks to the mobile devices. In addition, compiling the email addresses or mobile phone numbers of an entire audience may present difficulties: some members of the audience may be reluctant to share their email addresses and mobile phone numbers. A more general and streamlined solution to sharing files, selected/highlighted sections and links in an ad hoc manner may have many other applications, such as location-based proximity marketing.

There exists a continuing desire to advance and improve technology related to ad hoc file, selected/highlighted section and link sharing as well as location-based proximity marketing.

### SUMMARY

Systems, methods and techniques are disclosed for sharing files, selected/highlighted sections and links in ad hoc settings such as but not limited to gatherings, presentations, meetings, classes, lectures, trade shows and conferences, and for proximity marketing, ad hoc messaging and broadcast, cable and streaming shows, without direct two-way wireless communications between devices or email address or phone number exchange. A system may include a computing device and one or more mobile devices, communicatively couplable with a remote server using a first communications interface operable to transmit and receive Internet/network communications over WiFi, 3G/4G/LTE/5G, and Ethernet connections. A computing device comprises a computer readable memory, a processor, a display and one or more user input devices. A mobile device comprises a computer readable memory, a processor, a display, some method of user input, and is designed to be carried by a person. The system further includes a second communications interface operable to transmit and receive a Bluetooth Low Energy (BLE) Advertisement communications signal. The system may further comprise an Application stored in the computer readable memories of the computing device and one or more mobile devices.

The Application on the computing device may allow the user of the computing device to select a first package of data comprised of a file, selected/highlighted section or link, optionally with any combination of a graphical or text preview file, a description, an icon, a logo, an organization, company or group name (organization name), a content title, or content text, as well as the computing device user's metadata, comprising any combination of the user profile, username, alias, password, access level to features, Unique ID, Device ID, geolocation, user preferences and Message ID, and send the first package of data to the remote server over the first communications interface. Following confirmation of the reception of the first package of data by the remote server, the Application on the computing device may transmit one-way BLE Advertisements, the data payload of each BLE Advertisement containing a second package of data comprised of a Unique Identifier (Unique ID) and any combination of an Application Identifier (Application ID), Message Identifier (Message ID), Organization Identifier (Organization ID), flags, data, variables, values or commands to one or more mobile devices over the second communications interface. The remote server may generate a graphical or text preview of the file or selected/highlighted section if a preview was not sent by the Application on the computing device, and may generate a Message ID for use in the Bluetooth Low Energy Advertisement instead of or in addition to a Unique ID.

A mobile device may receive a BLE Advertisement containing a second package of data. The Application on the mobile device may extract the contents of the second package of data, identify the BLE Advertisement through the Application ID, and then query the remote server with the Unique ID and/or the Message ID to download and display any combination of a preview, a filename, a description, a link, an icon, a logo, file size, an organization, company or group name, a computing device username, an alias, the geolocation of the computing device, a content title, content text and applicable mobile device metadata in a notification, and inform the user of the mobile device of the arrival of a notification with an icon in the status or notification area, drawer, bar or screen of the mobile device, optionally with an audio/vibration alert. The notification may also be presented to the user of the mobile device in the Application on the mobile device, sorted and filtered with keywords from the description. The user of the mobile device may view the notification, and select or confirm the notification with a click, tap or swipe on the notification. The Application on the mobile device may download and display the file or selected/highlighted section to the user of the mobile device in an appropriate application or open the link in an appropriate application or provide the user of the mobile device an option to store the downloaded file, selected/highlighted section or link in the computer readable memory of the mobile device, or follow instructions or commands in the description.

The Application on the mobile device may retransmit BLE Advertisements which contain the second package of data sent by the computing device over the second communications interface to one or more additional mobile devices, which may be out of the Bluetooth Low Energy operating range of the computing device.

In some embodiments, the second package of data may be transmitted in the Service Set Identifier (SSID) or the Basic Service Set Identifier (BSSID) of WiFi beacon frames by the Application on a computing device and received. If the Application on a mobile device finds any combination of an Application ID, Unique ID, or Message ID in any combination of a received SSID or BSSID, the remaining elements of the second package of data may be extracted from the SSID or BSSID and a query sent to the remote server for a notification. The second package of data may be retransmitted in any combination of the SSID or the BSSID of WiFi beacon frames by the Application on a mobile device.

### BRIEF DESCRIPTION OF THE DRAWINGS

In the accompanying drawings, which illustrate one or more example embodiments,

FIG. 1 is a block diagram of a system with a laptop, presentation monitor, WiFi router, cell tower, Remote Server, and Mobile Devices, according to one embodiment;

FIG. 2 shows a method for sending a file with a preview from a Computing Device to one or more nearby Mobile Devices using a Unique ID in a Bluetooth Low Energy (BLE) advertisement; the file is sent though a Remote Server over the Internet without requiring phone numbers or email addresses.

### DETAILED DESCRIPTION

The terms computer program, application, applet, app, or script, as used in the present disclosure, refer to a set of instructions executable by a computer processor. A computer program, application, applet, app, or script may be standalone, may run under a computer operating system, or may be integrated within other computer programs, applications, applets, apps, scripts, or systems, such as a computer operating system. A computer program, application, applet, app, or script may be comprised of one or more routines.

A Computing Device, in the context of the present disclosure, refers to a device having a computer processor, computer readable memory, a display or the ability to drive one or more displays, some method of user input, such as a keyboard, discrete buttons, mouse or touchscreen, wireless and possibly wired Internet/network connections or interfaces, and may be portable or non-portable. Examples of Computing Devices include, without limitation, desktop computers, embedded computers, servers, laptops, tablets, smartphones, smartwatches, and virtual reality (VR) or augmented reality (AR) headsets. In the context of the present disclosure, a Computing Device also has Bluetooth 4.0+ with Bluetooth Low Energy (BLE) Advertising capability and may have WiFi and GPS capability.

A Mobile Device, in the context of the present disclosure, refers to a device having a computer processor, computer readable memory, a display, some method of user input such as a keyboard, discrete buttons, mouse, or touchscreen, wireless and possibly wired Internet/network connections or interfaces, and is designed to be portable, carried by a person while working or engaging in other activities. Examples of Mobile Devices include, without limitation, laptops, tablets, smartphones, smartwatches and virtual reality (VR) or augmented reality (AR) headsets. In the context of the present disclosure, a Mobile Device also has Bluetooth 4.0+ with BLE Advertising capability and may have WiFi and GPS capability. A near or nearby Computing or Mobile Device is a device within the operational range of a BLE signal or in some embodiments, a device within the operational range of a WiFi signal.

A computer program, application, applet, app, or script may run on a Computing Device or a Mobile Device in the foreground in a computer operating system, with a user interface appearing in front of all others on a display and able to support full user interaction. Alternately, a computer program, application, applet, app, or script may run on a Computing Device or a Mobile Device in the background in a computer operating system, not in front of all others on a display and unable to support full user interaction or may be invisible to the user. A background computer program, application, applet, app, or script may be caused to run in the foreground by user commands to the operating system, or by program, application, applet, app, script or operating system events that require user attention or interaction. A computer program, application, applet, app, or script may be stored in the computer readable memory of a Computer Device or Mobile Device.

The terms presenter, lecturer, and speaker, in the context of the present disclosure, are used interchangeably to refer to an individual giving a talk to an audience or leading a discussion with an audience with the aid of an electronic presentation, which may be comprised of any combination of slides, images, animations or videos, and which may be displayed by a Computing Device on, without limitation, a monitor, digital sign or television, on a screen using a projector, or on an array of other types of displays, such as VR or AR headsets. The presentation may reside in the computer readable memory of a Computing Device, which may be used to drive the display of the monitor, digital sign, television, projector, or VR or AR headsets through an HDMI, DisplayPort, VGA, or similar electronic cable, or through a wireless interface. A presenter, lecturer, or speaker may also be referred to a user of a Computing Device in the present disclosure and may also be a user of a Mobile Device.

An audience member, in the context of the present disclosure, refers to a person that attends a presentation given by a presenter, lecturer, or speaker in person. An audience member may also possess a Mobile Device and may also referred to as the user of the Mobile Device in the present disclosure.

A Cloud Computer, Cloud Server, Internet Server, Internet Cloud Server, or Remote Server, in the context of the present disclosure, all refer to a computer that has a processor and computer readable memory, and is capable of executing code consisting of programs, applications, applets, apps, or scripts, to provide computing, data and data storage services and may provide software license registration services to other computers and devices such as Computing Devices and Mobile Devices, through Internet/network connections. The user of a Computing or Mobile Device may interact with a Remote Server through a web-based (Internet) control panel, also called a dashboard. A Remote Server, referred to in the singular form in the present disclosure, may be comprised of a one or more computers in one location or may be comprised of more than one computer in a distributed computer system. A Remote Server may also be a virtual machine running on a Cloud/Utility Computing Service. In the context of the present disclosure, a Remote Server includes any programs, applications, applets, apps, or scripts, which may be stored in the computer readable memory of the Remote Server, required to perform the functions of the Remote Server. A Remote Server or Remote Server functionality may be accessed from a Computing Device or Mobile Device through Application Programming Interfaces (APIs). Function as a Service (FaaS) or similar platforms may also be used to provide access to a Remote Server or the functionality of a Remote Server. Computing Devices, Mobile Devices and the Remote Server connect to the Internet through Internet/network connections or interfaces.

A URL (Uniform Resource Locator) is a URI (Uniform Resource Identifier) that points to a resource on the Internet and may be the address of a specific webpage or file on the Internet. In the context of the present disclosure, a URL may be a shortened URL, redirected to an intended webpage or file by an Internet Server or URL redirect service, or a standard URL, which references the intended webpage or file directly. A website is a collection of one or more webpages. In the context of the present disclosure, the terms website and webpage may be used interchangeably, as both are accessed by URLs. A link is a connection from one part of an electronic document to another part of the document or another document. A URL may be embedded in a link, and the terms URL and link may be used interchangeably in the present disclosure.

Presentations for business meetings, instructive classes, or addresses in an auditorium first evolved from notes and diagrams written in real time on chalk boards and white boards to notes and diagrams written on clear transparent sheets using overhead projectors. The transparent sheets were often prepared ahead of time, using felt-tip markers. Later, computer and printing technology allowed the transparent sheets to be prepared and printed using digital fonts and computer graphics. Finally, electronic projectors and large flat-panel displays were developed, allowing individual “slides” prepared by programs such as Microsoft® PowerPoint® or Apple® Keynote® to be displayed directly to an audience, without the need to be printed on a transparent sheet.

Some members of the audience, meeting or class viewing a presentation may be too far away to see the presentation clearly, or their view may be partially or completely blocked by other members of the audience or class. Since most audience or class members carry a Mobile Device such as a laptop, tablet, or smartphone with them, making the presentation available for viewing on Mobile Devices near a presenter may allow the audience or class to follow the presentation more conveniently. In other cases, a presenter may want to provide the presentation to each audience member to review in detail at their convenience. Without each audience member's email account or in the case of some smartphone apps, without each audience member's phone number, sharing a presentation or more generally a computer file or link is cumbersome: a two-way connection over WiFi or Bluetooth or similar wireless network must be established from the presenter's Computing Device with each audience member's Mobile Device to transfer the file or link, or the file location (if available on a Cloud Server) or link must be entered manually by each audience member using a real or virtual keypad on a Mobile Device.

The present disclosure provides systems, methods and techniques to send files, selected/highlighted sections and links from a presenter's Computing Device to an audience's nearby Mobile Devices without acquiring the email accounts or phone numbers of the audience, and without establishing direct two-way wireless communications from a presenter's Computing Device to the audience's Mobile Devices, thus mitigating the security concerns of direct connections. The files, selected/highlighted sections and links are sent through an application on the presenter's Computing Device and audience's Mobile Devices, referred to as the Share App in the present disclosure. Once installed, the Share App may run as an always-on background application, switching to the foreground when user interaction is required, or may be started and stopped by an operating system in response to system events, such as the reception of a Bluetooth Low Energy (BLE) Advertisement. For some operating systems, scanning for BLE Advertisements is done by the operating system, and in some embodiments the Share App may need to run in the foreground of a Mobile Device to receive all BLE Advertisements from the operating system.

The Share App may allow the presenter to select or specify a First Package Of Data to send to the Remote Server. The first package of data may be comprised of a file, selected/highlighted section or link, optionally with any combination of a graphical or text preview file, a Description, an icon, a logo, an organization, company or group name, a content title, or content text, as well as the computing device user's metadata comprising any combination of the user profile, username, alias, password, access level to features, Unique Identifier, Device Identifier, geolocation, user preferences, and Message Identifier.

To activate the Share App, a presenter may select and click on a file (in some cases a right-click or long-click) to send on a Computing Device (sending device), which may be the Computing Device used to display a presentation to the audience or may be a different Computing Device. The file may be selected in a file browser or similar application and the Share App may be selected from a pop-up menu or sub-menu, and the file location may be automatically entered in the Share App's file selection or entry window. In some embodiments, a presenter may launch or activate the Share App from an icon or start/launch menu and select a previously sent file to send through a file selection menu, or if allowed by the Computing Device operating system, the presenter may select a new file to send through the file selection menu on the Share App's user interface. A file may also be selected in a program running on a Computing Device, such as but not limited to, an image, message, or video viewing program, either by selecting or clicking a preview or full view of the file in the program, using a click, right-click or a long-click and selecting the Share App from a menu or sub-menu, or by selecting the preview or full view of the file and clicking a menu option and selecting the Share App. A presenter may select or highlight a section or sections such as but not limited to text, messages or images in an application running on a Computing Device, click, right-click or long-click on the selected or highlighted section or sections to select the Share App from a pop-up menu or sub-menu or click on a menu option and select the Share App. The selected/highlighted section or sections may be converted to a file or files of any suitable format by the Share App, and automatically entered in the Share App's file selection or entry window. A presenter may also select and click on a link such as a URL in a program running on the Computing Device and select the Share App from a pop-up menu or sub-menu, the link automatically entered in the Share App's link selection or entry window, or copy-and-paste or manually enter a link in the Share App's link selection or entry window after launching the Share App from an icon or start/launch menu. In some embodiments, the operating system of a computing device may allow a file, selected/highlighted section or link to be shared, sent or added to the Share App through a menu selection or a pop-up menu using a click, right-click or long-click on the file, selected/highlighted section or link in a browser or program and the Share App manually started to select or access and file, selected/highlighted section or link within the Share App. The Share App may allow the selection, or by manual entry, the specification of additional elements used in a notification on a Mobile Device, such as but not limited to an icon, a logo (or multiple icons and logos), an organization, company or group name (organization name), a content title, content text, and a graphical or text preview file, which may be generated by the Share App, in addition to the selected file or link. A presenter may also select, or by manual entry, specify and upload a Description of the file, selected/highlighted selection or link to the Remote Server. The Description may contain keywords, categories, data, instructions and commands.

Upon presenter confirmation to share the file, selected/highlighted section or link, the Share App may upload the First Package Of Data, over or through one of the Computing Device's wired or wireless Internet/network connections or interfaces, using any suitable communications standard, such as but not limited to Ethernet, WiFi, or a cellular data link such as but not limited to 3G/4G/LTE/5G, to a Remote Server. In the First Package Of Data, the Message Identifier may be assigned by the Share App, may be incremented for every file or link sent by the Computing Device and may recycle after a certain number of files or links have been sent. The presenter's user preferences may instruct the Remote Server to generate a graphical or text preview file from the file, selected/highlighted section or link such as but not limited to the first page of a presentation, an image in low-resolution format or what the link points to in low-resolution format, if a preview file was not selected by the presenter or generated by the Share App. If an icon, logo, organization name, content title, content text, or preview file are not present in the First Package Of Data, the Remote Server may use just the filename or link as the content text. In some embodiments, the First Package Of Data may be uploaded to the Remote Sever as individual elements in any order. The Remote Server may check the file, selected/highlighted section, what the link points to, or the preview file for security threats such as viruses, trojans, or malware. The Remote Server may then confirm to the Share App on the sending Computing Device that the file, selected/highlighted section or link is ready to be shared. The Share App on the presenter's Computing Device may then transmit Bluetooth Low Energy (BLE) Advertisements, each BLE Advertisement's data payload containing a Second Package Of Data, comprised of a Unique Identifier (Unique ID) and any combination of an Application Identifier (Application ID), a Message Identifier (Message ID), an Organization Identifier, (Organization ID), flags, data, variables, values or commands, herein referred to as a Share App BLE Advertisement, for a time duration specified by the presenter in the Share App or a default time duration specified by the Share App. The presenter may also stop Share App BLE Advertisement transmissions manually. Part or all of the Second Package Of Data may be sent to the Remote Server with the First Package Of Data. The Share App BLE Advertisements may be received by the audience's Mobile Devices (one or more receiving devices).

When an audience member's Mobile Device receives a BLE Advertisement, the Share App on the Mobile Device may extract the data payload and check for an Application ID to confirm that the BLE Advertisement is a Share App BLE Advertisement. The Share App may extract the remaining elements of the Second Package Of Data from the data payload and query the Remote Server with the presenter's Unique ID and any combination of a Message ID or an Organization ID over one of the Mobile Device's Internet/network interfaces, such as but not limited to Ethernet, WiFi or a 3G/4G/LTE/5G cellular data link. The Remote Server may check if a presenter corresponding to the Unique ID recently uploaded a file, selected/highlighted section or link. If a Message ID was present in the Share App BLE Advertisement, it may be used to select a file, selected/highlighted section or link on the Remote Server corresponding to the Unique ID, and if a Message ID was not present, the latest file, selected/highlighted section or link corresponding the Unique ID may be used. If the file, selected/highlighted section or link has not expired, the icon, logo, organization name, content title, content text, and preview file, if selected or specified by the presenter, along with the file size and filename, or the link, if the presenter uploaded a link, may be downloaded by the Share App on the Mobile Device from the Remote Server. A subset of the presenter's metadata, which does not contain the presenter's password or access level, but may include the presenter's username or alias, may be downloaded as the Mobile Device metadata. The Mobile Device metadata may also include a link, index, file path or similar means of accessing the file or selected/highlighted section uploaded by the presenter on the Remote Server. The user of the Mobile Device may then be alerted or notified of the reception of the Share App BLE Advertisement, which may be any combination of sound, vibration, or an icon in the status or notification area, drawer, bar or screen of the Mobile Device, as specified in the presenter's or Mobile Device user's preferences. The user of the Mobile Device may then view the notification associated with the Share App BLE Advertisement, which may display the notification elements, which may be comprised of, without limitation, any combination of a preview, filename, link, icon, logo, file size, organization name, presenter's username, alias, geolocation, content title, or content text, in the status or notification area, drawer, bar or screen of the Mobile Device, typically by swiping up, down or sideways on the status or notification bar of a touchscreen display, or by clicking on a notification icon in a taskbar on a non-touchscreen display, along with other notifications. Upon user selection or confirmation of the notification with a click, tap, or swipe on the notification or on an action button in the notification, the Share App or the Operating System on the Mobile Device may download the file or selected/highlighted section, and open the file, selected/highlighted section or link in an appropriate application. For example, a URL link may be opened in a browser or any application capable of opening what the URL points to, a PDF file may be opened in a PDF viewer, a Microsoft PowerPoint file may be opened in Microsoft PowerPoint, an image file may be opened in an image viewer, and audio file may be opened and played in an audio player, a video file may be opened and played in a video player, etc. The Share App or operating system may also have built-in viewers for most common file types and may determine the file type based on the file extension or the file contents. The user of the Mobile Device may also be asked what to do with the file, selected/highlighted section or link or given the option to store the file, selected/highlighted section or link in the computer readable memory of the Mobile Device, which may be a default option for unrecognized file types.

The Mobile Device may retransmit the Share App BLE Advertisement sent by the Computing Device, to allow additional Mobile Devices, which may be out of the BLE operating range of the Computing Device, to receive the Share App BLE Advertisement for a time duration specified in the presenter's metadata, a value in the Share App BLE Advertisement, or a default time duration specified in the Mobile Device's Share App preferences.

The Bluetooth Low Energy standard defines Bluetooth Low Energy (BLE) Advertisements, also called BLE Advertising packets or BLE Advertisement packets, which are one-way transmissions on channels 37, 38, and 39 of BLE's 40 channels. The remaining channels, 0-36, are data channels. A BLE Advertisement has a data payload of up to 31 bytes, however most BLE Advertisement implementations support up to 20 bytes. A single BLE Advertisement may be received by one or more Mobile Devices, without the need to establish a two-way Bluetooth connection. Part of a BLE Advertisement's data payload may be used for a Unique ID, which provides a way to differentiate the BLE Advertisements of one Computing Device from another, and thus one presenter's Computing Device from another. Another part of the BLE Advertisement's data payload may be used for an Application ID which may be assigned to one or more values for the Share App (Share App ID(s)), to identify BLE Advertisements meant for the Share App (Share App BLE Advertisements). The remaining part of the BLE Advertisement's data payload may be used for a Message Identifier (Message ID), an Organization Identifier (Organization ID), flags, data, variables, values, and commands.

A Share App BLE Advertisement may be formatted as a Google® Eddystone®-UID BLE Advertisement, with the Share App BLE Advertisement Data Payload fitting into the 16-byte Eddystone-UID Namespace and Instance values. The Frame Type, Power and RFU values may also be used, for a total of 20 bytes. The entire ADV Data payload of 28 bytes may also be used.

A Share App BLE Advertisement may be formatted as an Apple iBeacon® BLE Advertisement, with the Share App BLE Advertisement Data Payload fitting into the 20-byte iBeacon Proximity UUID, Major and Minor values. The Company ID in an iBeacon may be set to 0x004C to be recognized as an iBeacon by Apple devices or to any future Company IDs defined by Apple. In some embodiments, a fixed 16-byte value for an Apple iBeacon Proximity UUID may be defined and used in Share App BLE Advertisements and in an Apple device application such as the Share App so that Share App BLE Advertisements are recognized by the Apple Device's operating system and provided to the Share App, in which case the Major and Minor values, totaling 4 bytes, may be used for a Unique ID and/or a Message ID, flags, data, variables, values or commands. Additional fixed Proximity UUIDs may be defined and used in Share App BLE Advertisements and in the Share App if the number of Unique IDs or Message IDs required by the Share App exceeds the number supported by the Major and Minor values totaling 4 bytes. The use of one or more fixed Proximity UUIDs in a Share App BLE Advertisement may collectively form an Application ID.

A Share App BLE Advertisement may be formatted as an AltBeacon® BLE Advertisement, with the Share App BLE Advertisement Data Payload fitting into the 20-byte AltBeacon Beacon ID. The Application ID may also be transmitted in the Alt Beacon's MFG ID field if an appropriate Bluetooth SIG Company Identifier is available.

A Computing Device may transmit Share App BLE Advertisements in multiple formats such as but not limited to Eddystone, iBeacon, AltBeacon and custom formats sequentially on each of the BLE Advertisement channels, to ensure that Mobile Devices configured to receive only one format of a BLE Advertisement will receive a Share App BLE Advertisement. Alternately, the Share App, a third-party application, an operating system setting or an Application Program Interface (API) may configure or enable the reception of all types or formats of BLE Advertisements, or of a single type or format of a BLE Advertisement on Mobile Devices which cannot receive all BLE Advertisements or the single type or format of BLE Advertisement natively, in which case a single type of an Eddystone, iBeacon, AltBeacon Share or custom App BLE Advertisement may be transmitted by a Computing Device on each of the BLE Advertisement channels and received by all types of Mobile Devices intended to receive Share App BLE Advertisements.

The BLE Advertisement Data Payload may also be used for a short URL, as is the case for Eddystone URL BLE Advertisements, which provide 17 bytes for compressed URLs. Compressed URLs longer than 17 bytes may be utilized by redirection of a shortened URL by an Internet Cloud Server. However, this redirection may require a setup on the Internet Cloud Server using a dashboard or an application running on a Computing Device with the long URL entered in the dashboard or application and using the shortened URL generated by the dashboard or application in the BLE Advertisement. The Share App allows a URL longer than a compressed length of 17 bytes to be shared with nearby Mobile Devices in a more streamlined manner, allows the URL to be checked by the Remote Server before it is sent to Mobile Devices, and allows more Mobile Devices to be reached by retransmitting the BLE Advertisements from Mobile Devices.

Bluetooth 5.0+ defines channels 37, 38, and 39 as primary advertisement channels, which may be used to send standard BLE Advertisements. In addition, the primary advertisements can carry a “common extended advertising payload” which contains the data channel and time offset for an extended advertising packet, which provides up to 255 bytes of payload data on a data channel, enough for most long URLs. The Share App may be configured to send a URL of up to 255 bytes directly to nearby Mobile Devices through a BLE 5.0+ extended advertising packet, and additional Mobile Devices may be reached by retransmitting the BLE Advertisements. As with Eddystone URLs, sending a URL through a Remote Server allows the website associated with the URL to be checked for security threats and inappropriate content by the Remote Server before it is sent to Mobile Devices.

Bluetooth Class 1 devices have up to 100 mW output power, which may provide up to 100 m+ operating range (range). Bluetooth Class 2 devices have 2.5 mW output power for approximately 10 m range, and Class 3 devices have 1 mW output power for approximately 1 m range. Because BLE Advertisements are one-way, Class 1 output power on a sending Computing Device may have 100 m+ range, even if receiving Mobile Devices are Class 2 or Class 3. The 100 m+ range of a Computing Device with Class 1 output power may be extended further with retransmissions of Share App BLE Advertisements by Mobile Devices. Computing Devices with Bluetooth Class 2 or Class 3 may by used at entry/exit points of large lecture halls or auditoriums or at entry/exit points of buildings to send Share App BLE Advertisements when an audience arrives or leaves if Bluetooth Class 1 is not available and in situations where retransmission of Share App BLE Advertisements is not desirable or practical. Increasing or decreasing the Bluetooth transmit power of a Computing Device to increase or decrease the operating range of BLE Advertisements, such as Class 1 or Class 2 Bluetooth output power decreased to Class 3 (1 mW or similar) output power, through a Share App, third party application or operating system setting, without retransmission of Share App BLE Advertisements by Mobile Devices may be desirable in some applications which have very small audiences, such as trade show booths or meetings in coffee shops, to avoid interfering with adjacent trade show booths or meetings and to ensure that only the Mobile Devices within approximately 1 m distance from the Computing Device receive the Share App BLE Advertisements. The Share App may increase or decrease BLE Advertisement output power automatically based on the file type or user preferences. If allowed by the Bluetooth hardware and operating system, the output power of a Bluetooth Class 1, Class 2 or Class 3 device may be varied (increased or decreased) within the Bluetooth Class, through a Share App or operating system setting, to provide a custom operating range. A value in the Share App BLE Advertisement may indicate a minimum Received Signal Strength Indicator (RSSI). A Share App BLE Advertisement received by a Mobile Device with an RSSI below the minimum RSSI value set in the Share App BLE Advertisement may be ignored by the Share App, allowing the Share App BLE Advertisement's operating range to be increased or decreased by increasing or decreasing the minimum RSSI value in the Share App BLE Advertisement.

The presenter's metadata may include some of the presenter's user preferences set in the Share App running on the Computing Device. The user of a Mobile Device may also set preferences in the Share App running on the Mobile Device. The Share App version may also pre-set or hard-code some or all the presenter or Mobile Device user Share App preferences. All uploads to, downloads from, and communications with the Remote Server by a Computing Device or a Mobile Device may be encrypted to ensure that login credentials such as a username and password and all other data cannot be intercepted by a third party.

The notifications from Share App BLE Advertisements may be presented with other notifications in the order they are received in the status or notification area, drawer, bar or screen of a Mobile Device. The Share App running on a Mobile Device may present the notifications to the user in the Share App, separate from the status or notification area, drawer, bar or screen, using any suitable arrangement, such as but not limited to the order the notifications are received, alphabetically, by organization, or as multiple lists arranged by categories or keywords parsed from notification elements and Descriptions, for the viewer's convenience and ease of use. The number of notifications to keep in the Share App notification list or lists may be a default number set by the Share App or may be configured by the user, and the notifications displayed in the Share App notification list or lists may persist when the notifications are dismissed or deleted from the Mobile Device's status or notification area, drawer, bar or screen. The Share App may be configured to alert the user by category or keyword in a notification element or a Description. Since the same Share App BLE Advertisement may received several times by a Mobile Device, in some embodiments, the Share App on the Mobile Device may add a notification for a newly received Share App BLE Advertisement to the current list of notifications in the status or notification area, drawer, bar or screen of the Mobile Device or to the current list or lists of notifications in the Share App if it is not currently in the notification lists.

The Share App may allow a presenter to select any combination of multiple files, selected/highlighted sections, or links along with applicable notification elements and Descriptions to be sent to nearby Mobile Devices utilizing one or more Share App BLE Advertisements repeating in a sequence after uploading the files, selected/highlighted sections, links, applicable notification elements and Descriptions to the Remote Server.

A presenter may specify, in a preference page or a popup dialogue of the Share App, or the Share App version may specify, the time duration for transmitting Share App BLE Advertisements. The user of the Mobile Device may view and select or confirm a notification associated with a Share App BLE Advertisement immediately upon being alerted to the reception of the notification, or at a later time, when the Mobile Device may no longer be in the BLE operational range of the Computing Device. The presenter may also specify, or the Share App version may specify, a time duration for a file, selected/highlighted section or link to remain active on the Remote Server, after which the file, selected/highlighted section or link will no longer be accessible by the Share App from Mobile Devices. A file, selected/highlighted section or link may be automatically deleted immediately after it has expired, deleted after a set time period, or deleted as part of a periodic cleanup of old files, selected/highlighted sections or links, by the Remote Server.

A presenter may specify, in a preference page or a popup dialogue of the Share App, or the Share App version may specify, a flag or setting to allow viewing only of a file, selected/highlighted section or link by Mobile Device users, without an option to store the file, selected/highlighted section or link locally on the Mobile Device, with the Share App providing the functionality to view most types of files natively, or a suitable application providing viewing only, and with the file or selected/highlighted section no longer viewable and the link no longer accessible after the presenter or Share App specified active time duration for the file, selected/highlighted section or link has elapsed.

A presenter may specify, in a preference page or a popup dialogue of the Share App, or the Share App version may specify, a flag in the Share App BLE Advertisement to request the Share App on a Mobile Device to retransmit Share App BLE Advertisements received from the presenter's Computing Device, to extend the presenter's BLE operating range. The presenter may also set or specify flags, data, variables, values or commands in the Share App, which may be carried in the BLE Advertisement's payload. Values may be set to specify a delay to the start of the retransmissions, the duration of the retransmissions, and the maximum number of number hops from the sending Computing Device to the last receiving Mobile Device (to limit the range of the retransmissions) and the current hop number (updated by a Mobile Device on each hop). In embodiments that use a Unique ID only or the equivalent of a Unique ID only in the Share App BLE Advertisement, Mobile Devices may delay retransmissions by a fixed or variable time period and the Remote Server may estimate the number of hops by checking for peaks in Unique ID queries. Once the estimated number of hops has been reached, the Remote Sever may instruct the last set of Mobile Devices to cease retransmissions of the Share App BLE Advertisement. The retransmissions will also stop once there are no additional Mobile Devices with a Share App installed and running within range of the last retransmitting Mobile Device. The Share App on a Mobile Device may limit unnecessary retransmissions of the BLE Advertisement by only retransmitting if the RSSI of the received BLE Advertisement is below a set level relative to the calibrated BLE Advertisement output power: a Mobile Device close to the sending Computing Device will have a higher RSSI than Mobile Devices further away and may not reach more Mobile Devices further away than the Computing Device. A Share App BLE Advertisement may be retransmitted by a Mobile Device without waiting for user selection or confirmation of the notification associated with the Share App BLE Advertisement with a click, tap or swipe on the notification.

A presenter may specify, in a preference page or a popup dialogue of the Share App, a security code or password with the number of possible retries, sent with the presenter's metadata to the Remote Server, the security code to be entered by the users of the Mobile Devices to ensure that unauthorized Mobile Device users cannot access confidential files, selected/highlighted sections or links. When a security code is specified, the Share App on a Mobile Device may delay downloading of some notification elements, such as but not limited to preview files, descriptions and links, until the security code by the user of the Mobile Device is entered and verified. The security code may be kept short so that it may be entered quickly by users, with a numeric-only format or any combination of numeric, text or special characters. The presenter may provide the security code to the audience verbally or on a whiteboard or similar presentation apparatus. The Share App may also provide the ability to authenticate users based on their geolocation, determined by, without limitation, GPS, WiFi/Cellular triangulation, IP address or similar means, or the last known geolocation in the case of indoor use, alone or in combination with a security code, to ensure that only Mobile Device users within a presenter-specified radius of presenter's Computing Device location have access to the file, selected/highlighted section or link.

A presenter may specify, in a preference page or a popup dialogue of the Share App, a flag and/or value in the Share App BLE Advertisement to request the Share App or operating system on Mobile Devices receiving Share App BLE Advertisements to scan for BLE Advertisements more frequently than the nominal rate for a specified time duration or until a Share App BLE Advertisement is received specifying scanning at the nominal rate, with the flag indicating faster scanning and the value indicating the scan frequency or period. Depending on the operating system's requirements, the Share App on the Mobile Device may need to be in the foreground for more frequent BLE Advertisement scanning. More frequent BLE Advertisement scanning will allow subsequent Share App BLE Advertisements to be received with reduced lag during a presentation and will reach Mobile Devices receiving retransmitted Share App BLE Advertisements through several hops faster. An empty Share App BLE Advertisement sent at the beginning of the presentation, with the flag and/or value to scan for BLE Advertisements more frequently set but no associated file, selected/highlighted section or link, will allow the first non-empty Share App BLE Advertisement to be received with minimal lag. More frequent BLE Advertisement scanning may be set to expire if a Share App BLE Advertisement has not been received for a presenter or Share App specified time duration to minimize battery drain.

A script or application running on a Computing Device or Remote Server may be configured to use the Share App, or the Share App may directly support the ability to send files, selected/highlighted sections or links, on a schedule set by a presenter to nearby Mobile Devices. A presentation application running on a Computing Device may be designed or configured to automatically use the Share App to send files, selected/highlighted sections or links to an audience's Mobile Devices, as they are encountered in the presentation.

A Share App BLE Advertisement may contain commands for a file, selected/highlighted section or link sent by a previous Share App BLE Advertisement. An example of a command is automatic page or slide flipping for a presentation on Mobile Devices (with minimal lag with faster BLE Advertisement scanning) or flip to a specific page or slide, as a presenter flips through pages/slides in the presentation on the sending Computing Device. Commands may also be sent to start/stop animations within a page or slide or to start/stop videos embedded in a page or slide. Commands, including commands for page flipping, animation start/stop or video start/stop may also be sent by the Share App on the Computing Device to the Share App on the Mobile Device through the Remote Server through an Internet/network connection.

A Unique ID, which may be globally unique, may be assigned to a presenter or to a Computing Device or to the user of a Mobile Device or to a Mobile Device by the Share App or by the Remote Server using any suitable algorithm during or after installation or in some embodiments, during or after installation and registration of the Share App on a Computing Device or on a Mobile Device, and may occasionally be reassigned. The Remote Server may also assign a Device ID, which may be globally unique, to a Computing or Mobile Device. The Device ID may be associated with a globally unique username, which may be an email address, and a password chosen by the user of a Computing Device or Mobile Device, or the Device ID may be assigned by the Remote Server using any suitable algorithm, and may occasionally be reassigned, and may be used with the Unique ID as login credentials when uploading to, downloading from, or communicating with the Remote Server as an alternative to a username and password. Since the Device ID is not transmitted as part of a Share App BLE Advertisement, the Device ID and Unique ID may be used as secure login credentials by the Share App on a Computing Device when uploading files or data to or downloading files or data from the Remote Server or when communicating with the Remote Server over an encrypted Internet/network connection. The Remote Server may prevent unauthorized downloads by restricting downloads to Mobile Devices with verified login credentials and the correct Unique ID for a file, selected/highlighted section or link.

In some embodiments, the Share App running on a Mobile Device may ignore a newly received Share App BLE Advertisement if a Share App BLE Advertisement with the same Unique ID had been previously received within a default or viewer-configurable time period, even if it is not currently in the list or lists of Share App BLE Advertisement notifications made available to the viewer. A different Message ID may be used to differentiate a new Share App BLE Advertisement from a previously received Share App BLE Advertisement with the same Unique ID. The Share App may also be configured by the user to ignore Share App notifications received from the Remote Server based on categories or keywords in notification elements or Descriptions.

In addition to an Application ID, Message ID, and Unique ID, a Share App BLE Advertisement may contain an Organization Identifier (Organization ID), to differentiate the Computing Devices of one organization from another. In some embodiments, the Share App running on a Mobile Device may ignore Share App BLE Advertisements, based on Organization IDs, from certain organizations as specified by the user of the Mobile Device. Without an Organization ID in a Share App BLE Advertisement, notifications from the Remote Server resulting from Unique ID queries associated with certain organizations may be ignored by the Share App, as specified by the user of the Mobile Device, based on organization names in notification elements provided by the Remote Server.

The user of a Computing Device may request registration of the Computing Device with an organization through the Share App and may request registration with more than one organization. An organization administrator, logged into the Remote Server, may grant registration through a dashboard on the Remote Server, based on the user's username or Device ID, and optionally based on the user's geolocation. An organization and organization administrators may be approved by a Share App administrator (also referred to as a Remote Server Administrator in the present disclosure) through a dashboard on the Remote Server, by email, phone or through a website. A Share App administrator may also approve and create an organization on the Remote Server at the request of an organization, company or group. The user of a Computing Device which is registered to more than one organization may select an organization from a preference or dialog page on the Share App when sending a file, selected/highlighted section or link to nearby Mobile Devices. An organization administrator may lock the Computing Device's icon, logo, organization name and alias for notifications sent in the name of the organization. The Remote Server may restrict the use of an organization name in a notification to Computing Devices registered to the organization.

The user of a Mobile Device may be provided with Share App options to filter or ignore Share App BLE Advertisements, such as but not limited to ignoring Share App BLE Advertisements from presenters unless they are registered with an organization, receiving Share App BLE Advertisements only if the Share App is running as a foreground application, and receiving Share App BLE Advertisements from presenters who are not registered with an organization only if the Share App is running as a foreground application. The user of a Mobile Device may request registration of the Mobile Device with an organization through the Share App and may request registration with more than one organization. A presenter may send a registration notification to nearby Mobile Devices through the Share App, which when confirmed by the user of a Mobile Device, may automate registration with the organization. An organization administrator logged in to the Remote Server may grant registration through a dashboard on the Remote Server, based on the Mobile Device user's username or Device ID, and optionally based on the user's geolocation and time of request. A presenter, when using a Computing Device to send a file, selected/highlighted section or link to nearby Mobile Devices may, through a preference page or a popup dialogue of the Share App, select one or more organizations and select or specify an option to restrict the sending of notifications by the Remote Sever in response to queries by Mobile Devices related to Share App BLE Advertisements sent by the Computing Device only to Mobile Devices registered with at least one of the selected organizations, and exclude Mobile Devices not registered to any of the organizations.

In some embodiments, registration with an organization may be granted to users of Computing Devices rather than or in addition to Computing Devices to allow a presenter to use more than one Computing Device with the same username/password to send files, selected/highlighted sections or links for an organization to nearby Mobile Devices using the Share App. In some embodiments, registration with an organization may be granted to the users of Mobile Devices rather than or in addition to Mobile Devices to allow a user of a Mobile Device to use more than one Mobile Device with the same username/password to receive files, selected/highlighted section or links associated with an organization from nearby Computing Devices using the Share App.

An organization administrator may define a subset of an organization through a dashboard on the Remote Server. In some embodiments, a presenter, when sending a file, selected/highlighted section or link to an organization or a subset of the organization, may specify through a preference page or popup dialogue in the Share app, that the Remote Server send notifications only in response to queries by Mobile Devices registered to the organization or a subset of the organization resulting from the reception of Share App BLE Advertisements by the Mobile Devices, or that the Remote Server send notifications to all Mobile Devices registered to the organization or a subset of the organization, with or without receiving queries from the Mobile Devices resulting from the reception of Share App BLE Advertisements by the Mobile Devices.

In some embodiments, a Computing Device registered to an organization may periodically query the Remote Server and be commanded, or the Remote Server may periodically query the Computing Device and command the Computing Device, to transmit Share App BLE Advertisements for a notification for a file, selected/highlighted section or link, stored in the computer readable memory of the Computing Device the Remote Server, to nearby Mobile Devices on behalf of the organization without any intervention or commands by the user of the Computing Device.

In some embodiments, the geolocation of the Computing Device, as determined by GPS, WiFi/Cellular triangulation, IP address, or similar means, may be included in the presenter metadata sent to the Remote Server with the file, selected/highlighted section or link. A notification on a Mobile Device may display the geolocation as co-ordinates, nearest street intersection, building, postal code, or city. An action button on the notification may be used to launch a map application on the Mobile Device, with the geolocation highlighted as a reminder of where the notification was received if the user of the Mobile Device does not click on the notification immediately after receiving the notification. The geolocation of a received notification may also be generated by the Mobile Device by GPS, WiFi/Cellular triangulation, IP Address, or similar means. The notification may also display the time the notification or the Share App BLE Advertisement was received, and combined with the geolocation, may aid the user of a Mobile Device in remembering when and where the notification was received.

In some embodiments, notifications received by Mobile Devices from the Remote Server may be tracked, with time stamps and geolocation data, by Computing Device or presenter Message ID, Unique ID, Device ID, Organization ID and username by the Remote Server and notification follow-throughs, also called click-throughs (by clicks, taps or swipes on the notifications) on Mobile Devices may be tracked separately, with time stamps and geolocation data, by Computing Device or presenter Message ID, Unique ID, Device ID, Organization ID and username by the Remote Server, with the statistics for notifications received and follow-throughs displayed to the presenter on the Share App by file, link or selected/highlighted section sent by the presenter, numerically as a listing or a table, or graphically as a bar graph or a time plot or any other suitable format. The statistics, with time stamps and geolocation data, may also be provided to the presenter or an organization administrator logged into the Remote Server on a dashboard within reports or may be downloaded by the presenter or organization administrator from the Remote Server in any suitable format, such as, without limitation, formatted text files, comma-separated volume files, Excel® spreadsheet files, PDFs, or database files.

A Description downloaded by the Share App running on a Mobile Device from the Remote Server may contain instructions or commands in addition to keywords, categories and data. The instructions or commands, upon user confirmation, may be sent to the operating system by the Share App on the Mobile Device, to launch an application or service with data from the Description. Subsequent Share App BLE Advertisements with a Unique ID that previously launched an application or service on a Mobile Device, but with an updated Message ID may provide an updated Description to provide an update to the launched application or service, with or without re-launching the application or service. The Share App may process the update according to user preferences: always confirm with the user or perform the update without confirmation.

In some embodiments, a Description, content text or a file downloaded by the Share App running on a Mobile Device from the Remote Server may include a social media symbol, label or tag, such as “#” or “@” followed by additional information or an identifier. The Share App may take appropriate action if the user clicks, taps, or swipes on the notification with the symbol, label, tag, additional information or identifier, such as, without limitation and upon additional user confirmation of the intended action, directly opening a social media website specified in the Description or associated with the symbol, label or tag in a browser, and entering the label or tag along with the additional information or identifier, such as but not limited to a search term or a username, in an appropriate location in the webpage.

In some embodiments, a Description, content text or a file downloaded by the Share App running on a Mobile Device from the Remote Server may include an email address. In certain embodiments, the email address may be followed by additional information. The Share App may take appropriate action if the user clicks, taps, or swipes on the notification with the email address and additional information, such as, upon additional user confirmation of the intended action, opening an email application or a web-based email service with the “To” section automatically filled with the email address. The additional information, along with user data from the Mobile Device, may specify the subject and a part or the entire contents of the email.

In some embodiments, a Description, content text or a file downloaded by the Share App running on a Mobile Device from the Remote Server may include a phone number. The phone number may be followed by additional information in certain embodiments. The Share App may take appropriate action if the user clicks, taps, or swipes on the notification with the phone number and additional information, such as, upon additional user confirmation of the intended action, making a standard or VOIP phone call or sending a text message using the phone number. The additional information may be the contact name, or part or all of the text message. The Share App may, upon user confirmation, add the phone number and contact name to the list of contacts on the Mobile Device.

In some embodiments, a Description, content text or a file downloaded by the Share App running on a Mobile Device from the Remote Server may include contact, meeting, appointment, or electronic business card information. The Share App may take appropriate action if the user clicks, taps, or swipes on the notification with the contact, meeting, appointment or business card information, such as, upon user confirmation of the intended action, adding a contact to an email or phone contact list, adding a meeting or appointment to a calendar application, or adding an electronic business card to a list of electronic business cards. At a meeting, conference, or event at a venue, a Description, content text, file or link downloaded by the Share App running on a Mobile Device from the Remote Server may provide information on the next meeting, conference or event of the same series at the current venue or different venue, or a meeting, conference or event at the current venue unrelated to the at the current meeting, conference or event, along with booking and payment options. The Share App may take appropriate action if the user clicks, taps, or swipes on the notification with the information on the next meeting, conference or event such as, upon additional user confirmation of the intended action, adding the meeting, conference, or event to a calendar application, opening the link in a browser, and opening a payment application.

In some embodiments, the Share App may provide the user of a Mobile Device with an option to register or file a complaint against a presenter if inappropriate or offensive files, selected/highlighted sections or links were sent by a presenter to Mobile Devices. Repeated offenses by a presenter may result in the suspension or banning of the presenter by an organization administrator if the presenter is registered with an organization or by a Share App administrator. In some embodiments, the user of a Mobile Device may specify and upload user preferences to the Remote Server, including but not limited to the filtering of notifications for unwanted or inappropriate files, selected/highlighted sections or links by category, organization, or organization type, the filtering of file types and sizes, and the filtering of specific presenters, with the option to not receive a notification for a filtered link, file or presenter. Mobile Device user preferences may also be kept on the Mobile Device, with the Share App providing the filtering services.

In some embodiments, a presenter may be a retailer and may use the systems, methods and techniques of the present disclosure for location-based proximity marketing, with or without giving a formal presentation. The Share App running on a Computing Device, with or without a connected display such as but not limited to a monitor, digital sign, television or projector, may be used to send notifications for files, selected/highlighted sections or links to provide information, specials, discounts, flyers, advertisements, coupons or other promotional offers to users of nearby Mobile Devices. A text or graphical coupon may be redeemed by displaying it to a cashier, a 1D or 2D barcode coupon may be redeemed at a retail location by scanning it at a cashier location, and a text coupon code may be automatically entered in a webpage pointed to by a link by the Share App. A file or Description sent by a Computing Device may contain instructions for an application such as wallet or payment app on the mobile phone.

In some embodiments, systems, methods or techniques to provide updated specials, discounts, flyers, coupons or other promotional offers for location-based proximity marketing may be implemented by tracking received notifications and notification follow-throughs (clicks, taps or swipes) for specials, discounts, flyers, coupons or other promotional offers on the Remote Server, with the statistics processed to produce optimal follow-through results for specific or updated specials, discounts, flyers, coupons or other promotional offers, or categories of specials, discounts, flyers, coupons or other promotional offers, which may include updates for a time period lasting until the next updates, or for a particular time, wherein the particular time may be, without limitation, the time of day, day of the week, the month, or a season.

In some embodiments, a Mobile Device user's search history, preferences, previously launched applications or services, received and followed-through notifications, links or URLs, purchases and other related information, stored in the user's Mobile Device or in an Internet Server or the Remote Server, alone or along with categories in notification elements or Descriptions or keywords defined by the user, may be used to provide customizations or options such as, without limitation, customizations and selection of inline advertisements for the Share App or applications or services launched by instructions in Descriptions, customizations and selection of advertisements on webpages launched by a link, or customizations and selection of proximity marketing specials, discounts, flyers, advertisements, coupons or other promotional offers sent to the user's Mobile Device by a Computing Device.

In some embodiments, the Share App on a Computing or Mobile Device may periodically report its status and geolocation through GPS (if available), WiFi/Cellular triangulation, IP address, or similar means to the Remote Server. The Remote Server may also periodically query the Share App on a Computing or Mobile Device by its Unique ID or Device ID to retrieve its status and geolocation. The Remote Server may track each Mobile Device based on its geolocation, sorted using any suitable arrangement, such as, without limitation, by geographic region, country, state/province, city and district or equivalent geographic division/hierarchical system, by postal or zip code or an area defined by a latitude/longitude graticule.

In some embodiments, a Share App administrator may command the Remote Server to send a notification to Computing and Mobile Devices, globally, or for a particular geographic region, country, state/province, city, or district, or for a postal/zip code or a region defined by a latitude/longitude graticule. The geographic region, country, state/province, city, or district, or for a postal/zip code or a region defined by a latitude/longitude graticule may be used to select a file, selected/highlighted section or link along with applicable notification elements and a Description to send to the Computing and Mobile Devices, or a global file, selected/highlighted section or link, applicable notification elements and Description may be selected. The notification text, or the file, selected/highlighted section or link, downloaded and opened in an appropriate application once the notification is selected with a click, tap or swipe on the notification, may provide a public service announcement, alert, or warning.

A presenter may specify, in a preference page or a popup dialogue of the Share App on a Computing Device, a radius within which to send a notification for a file, selected/highlighted section or link to Mobile Devices. Upon presenter confirmation, the Share App on the Computing Device may send the file, selected/highlighted section or link along with applicable notification elements and a Description to the Remote Server. The Remote Server may send notifications to Mobile Devices within the specified radius of the Computing Device, based on the geolocation of the Computing Device. The complexity of searching for Mobile Devices within the radius set by the presenter may be reduced by tracking the geolocations of Mobile Devices and limiting the searches to Mobile Devices within the district, postal/zip code or an area defined by a latitude/longitude graticule that the Computing Device is located in, and the nearest neighbors of the district, postal/zip code or the area defined by a latitude/longitude graticule that the Computing Device is located in. The precision of the radius is subject to the precision of the available geolocation method or methods. The Share App may have a built-in limit for the radius, or the Remote Server may limit the radius to a value set by a Share App administrator. The presenter may also specify one or more organizations when sending a file, selected/highlighted section or link to the Remote Server, and the Remote Server may restrict the sending of notifications for the file, selected/highlighted section or link to Mobile Device users who are members of one of the specified organizations. Once the user of a Mobile Device clicks, taps or swipes on a notification, the file or selected/highlighted section may be downloaded and opened, or the link may be opened, in an appropriate application.

In some embodiments, the Remote Server may store a presenter's related sets of data, each set comprised of a file, selected/highlighted section or link, optionally with notification elements, metadata and a Description, and allow a presenter to select which set to send to Mobile Devices through the Share App, the selection made on the Share App or by logging in to the Remote Server through a dashboard, without the need to resend the set to the Remote Server. Related sets of files, links, selected/highlighted sections, notification elements and Descriptions may be added, deleted or updated on the Remote Server by a presenter through the Share App or through a dashboard on the Remote Server.

In some embodiments, a Computing Device may store related sets of data, each set comprised of a file, selected/highlighted section or link, optionally with notification elements, metadata and a Description, and allow a presenter to select which set to send to Mobile Devices through the Share App, the selection made on the Share App, without the need to reselect or re-specify each set's individual components.

A file, preview file, selected/highlighted section or Description may contain, in any language, with or without data compression, any combination of text, text using a markup language, data, vector or pixel-based graphics or images, social media symbols, labels or tags, email addresses, phone numbers, contacts, electronic business cards, video files, audio files, barcodes, or coupons, which may be displayed in a notification or appropriate viewer or may be passed to an application launched by the Share App or already running on the Mobile Device. A file, preview file, selected/highlighted section or Description may also contain any combination of instructions, commands, data or scripts, which may be passed to an application launched by the Share App or already running on the Mobile Device, or may contain any combination of programs, applications, applets, apps, or scripts to be launched by the Share App. A link or URL may be comprised, in any language, of any combination of text or text using a markup language, with or without data compression.

The Share App may be implemented to run as a single version on Computing Devices and Mobile Devices (device application) or may be implemented to run as one version on Computing Devices (computing device application) and as a second version on Mobile Devices (mobile device application). A single-version Share App or a Share App version implemented for a Computing Device, when installed on a Computing Device, may restrict the Computing Device's functionality to that of a Mobile Device until the user of the Computing Device registers the Share App with the Remote Server.

A Computing Device, when not used by the Share App to share files, selected/highlighted sections, and links with nearby Mobile Devices, may act as a Mobile Device and receive files, selected/highlights sections and links from other Computing Devices. A Mobile Device, if allowed by the Share App version running on the Mobile Device and when commanded by the user of the Mobile Device, may act as a Computing Device to send files, selected/highlights sections and links to other Mobile Devices.

A Share App BLE Advertisement may be comprised of a BLE Advertisement with a data payload comprised of a Unique ID and any combination of an Application ID, Message ID, Organization ID, flags, data, variables, values or commands, or a Message ID and any combination of an Application ID, Unique ID, Organization ID, flags, data, variables, values or commands. In some embodiments, a Share App BLE Advertisement may contain a Unique ID only. Upon reception of a Share App BLE Advertisement with only a Unique ID by a Mobile Device, the Share App may query the Remote Server with the Unique ID to confirm the application identity of the BLE Advertisement, by confirming that a presenter with the Unique ID has uploaded a file, selected/highlighted section or link that is still active on the Remote Server. The Message ID, Organization ID, flags, data, variables, values and commands manually entered, selected or set as preferences by a presenter or by the Share App on the Computing Device for the latest file may be uploaded to the Remote Server, and may be provided to the Share App on the Mobile Device by the Remote Server if the Unique ID is confirmed to be for the Share App and a file, selected/highlighted section or link associated with the Unique ID is still active on the Remote Server.

The contents of a Share App BLE Advertisement's data payload may be referred to as the Second Package Of Data in the present disclosure. In some embodiments, part or all of the Second Package Of Data may be encrypted on a Computing Device using an encryption key provided by the Remote Server over an encrypted Internet/network connection and decrypted on a Mobile Device using a decryption key provided by the Remote Server, or the Second Package Of Data may be sent to the Remote Server by the Mobile Device, decrypted on the Remote Server and the decrypted contents of the Second Package Of Data sent back to the Mobile Device over an encrypted Internet/network connection.

In some embodiments, the Share App on a Computing Device may query the Remote Server for a globally unique Message ID for use in a Share App BLE Advertisement when a file, selected/highlighted section or link is sent by a presenter using the Share App on a Computing Device to the Remote Server. The Remote Server may use any suitable algorithm to generate a globally Unique Message ID. The Share App on a Computing Device may transmit Share App BLE Advertisements with a Second Package Of Data comprised of the Message ID and any combination of an Application ID, Unique ID, Organization ID, flags, data, variables, values or commands. The Share App on a Mobile Device, upon receiving a Share App BLE Advertisement with a globally unique Message ID, may query the Remote Server with the Message ID instead of a Unique ID and any combination of a Unique ID or an Organization ID for a notification. In some embodiments, the number of available globally Unique Message IDs may be limited, such as when restricted to the Major and Minor values of an iBeacon, in which case the Remote Sever may recycle Message IDs once the file, selected/highlighted section or link associated with the Message ID has expired. When downloading a file, selected/highlighted section or link, the presenter's Unique ID, part of the presenter's metadata, may be used in addition to the Message ID to ensure that the correct file, selected/highlighted section or link is downloaded if Message IDs are recycled. Alternately, a link, index, file path or similar means of accessing an uploaded file, selected/highlighted section or link on the Remote Server may sent by the Remote Server as part of the Mobile Device metadata. In some embodiments, a locally unique Message ID may be generated by the Remote Server for every file, selected/highlighted section, or link sent by the Share App on a Computing Device to the Remote Server. The locally unique Message ID may be local to a geographic region, country, state/province, city, or district, and combined with the geolocation of the Computing and Mobile Devices through GPS, WiFi/Cellular triangulation, IP address or similar means, to provide a Message ID which is effectively globally unique for queries by Mobile Devices. As with globally unique Message IDs, locally unique Message IDs may be recycled by the Remote Server once the file, selected/highlighted section or link has expired.

In some embodiments, the Share App on a Mobile Device may store received Share App BLE Advertisements or store the Second Packages Of Data extracted from the data payload of Share App BLE Advertisements, in the computer readable memory of the Mobile Device if an Internet/network connection or interface is not available when the Share App BLE Advertisements are received. The Share App may query the Remote Server with elements extracted from the stored Share App BLE Advertisements or the stored Second Packages Of Data when an Internet/network connection or interface becomes available, download and display the notifications associated with the received Share App BLE Advertisements to the user of Mobile Device, and delete the stored Share App BLE Advertisements or Second Packages Of Data from the computer readable memory of the Mobile Device. If an associated file, selected/highlighted section or link for a stored Share App BLE Advertisement has expired before an Internet/network connection becomes available, the Remote Server may ignore the query or may indicate in the notification or in a popup message that the file, selected/highlighted section or link is no longer available.

In some embodiments, the Share App on a Mobile Device may provide, in a preference page or popup dialogue, an option to ignore all Share App BLE Advertisements for a set time period or until the user enables reception of Share App BLE Advertisements. An additional option may be provided in the Share App to ignore all notifications from the Remote Server: no audio or vibration alerts, no icons in the status or notification bar of the Mobile Device and no notifications in the status or notification area, drawer, bar or screen of the Mobile Device, for a set time period or until the user turns on notifications from the Remote Server. A third option may be provided in the Share App to add ignored notifications from the Remote Server to the Share App's list of notifications, accessible in the Share App only.

The present disclosure may be used to implement or may be used as part of a proximity ad hoc messaging system. A presenter may send a text message, typed on a virtual or real keypad on a Computing Device to all nearby Mobile Devices or only to those registered to an organization selected by a presenter. The Share App may send the text message in any combination of a file, Description or content text, with an attachment such as an image, video, or selected/highlighted section in a file, or a URL as a link to the Remote Server. The presenter's Computing Device may then transmit Share App BLE Advertisements. The user of the Mobile Device may click, tap, or swipe on a notification from the Remote Server associated with the Share App BLE Advertisement to download and view the message using a suitable viewer. The messages may also be viewed in the Share App or a third-party application, using any suitable arrangement, such as but not limited to the order in which the messages were received, or arranged by the organization name, the presenter's username or alias, or the content title, which may also be the subject matter of the message. The user of a Mobile Device, if allowed by the Share App version running on the Mobile Device, may act as a presenter, and respond to a message sent by a presenter.

The present disclosure may be used to send files, selected/highlighted sections, links or Descriptions associated with broadcast, cable or streaming programs, content, movies or shows (herein referred to as shows) to Mobile Devices. A broadcast, cable or streaming organization administrator may act as a presenter and upload any combination of files, selected/highlighted sections, links or Descriptions associated with a show, globally, or by geographic region, country, state/province, city or district, to the Remote Server through the Share App on a Computing Device or through a dashboard on the Remote Server. The Share App, installed on a Computing Device integrated into a television, set-top box or streaming player, may send information on the broadcast or cable channel or streaming show currently playing on the television, the broadcast, cable or streaming provider, and metadata including a Unique ID to the Remote Server, with the information updated whenever the channel or streaming program is changed. Alternately, the Remote Server may periodically query the Share App on a Computing Device integrated into a television, set-top box or streaming player based on the Computing Device's Unique ID or Device ID for information on the broadcast or cable channel or streaming show currently playing on the television and the broadcast, cable or streaming provider. The Remote Server may command the Computing Device to transmit Share App BLE Advertisements for the broadcast, cable or streaming show when the administrator for the broadcast, cable or streaming provider wishes to send a notification for a file or link to Mobile Device users watching the show, such as but not limited to a file, selected/highlighted section, link or Description related to a news story in a news show, a contest or charity show, a product placement in a show, or a commercial. Notifications for files, selected/highlighted sections, links or Descriptions unrelated to the show or content currently playing on a television may also be sent by the Remote Server to Mobile Devices, by an administrator for a broadcast, cable or streaming provider, by an advertiser, by a government agency, or by a Share App administrator.

The administrator may specify on the dashboard on the Remote Server if notifications are to be sent to a Mobile Device only if the user is a member of the administrator's organization, or if notifications are to be sent for all Mobile Devices queries. When registering the Share App with a cable or streaming provider, a Mobile Device user may provide login credentials for the cable or streaming service and may receive notifications on a Mobile Device directly from the Remote Server through the Share App over an Internet/network connection without receiving a Share App BLE Advertisement from a Computing Device, as the cable or streaming provider will be aware of which show is currently playing on the Mobile Device user's television. The geolocation of the Mobile Device may be used to confirm that the Mobile Device user is near the television, and if the Mobile Device is not near the television, the user of the Mobile Device may be given an option to stop receiving notifications until the Mobile Device is near the television. A Mobile Device displaying streaming content from a streaming provider may receive notifications directly from the Remote Server through the Share App over an Internet/network connection. Once the user of a Mobile Device clicks, taps or swipes on a notification, the file or selected/highlighted section may be downloaded from the Remote Server and opened, or the link may be opened in an appropriate application, or an application may be launched using instructions in the Description.

The Share App may be launched from a third-party application or a script on a Computing Device, with a file, link, applicable notification elements and Description automatically generated or selected and filled in when the Share App is launched. An example is a calendar app and sharing an appointment or meeting with an audience. A presenter may create a meeting on the calendar app, click, right-click or long-click on the meeting and select the Share App from a pop-up menu or sub-menu or click on a menu option and select the Share App. The calendar app may generate a Description which contains instructions and data to update a calendar app on a Mobile Device. The presenter may then send the Description to nearby Mobile Devices using the Share App. The Share App may be launched from a third-party application or a script on a Mobile Device. The calendar app may be updated automatically with the appointment or meeting once the user of a Mobile Device selects or confirms the received notification. A third-party application, such as but not limited to a calendar app or ad hoc messaging app, or a script may launch or use the Share App or part or all of the functionality of the Share App with or without launching the Share App's user interface.

The systems, methods and techniques of the present disclosure may be implemented in an existing infrastructure of Computing Devices, Mobile Devices, Ethernet, WiFi and Cellular Data Internet/network connections, and Remote/Internet/Cloud Servers, without the deployment of new hardware or the deployment of new hardware features, add-ons or modifications to existing hardware. Alternately, specialized add-on hardware that provides Class 1 BLE transmit power, such as but not limited to a plug-in device for a USB port, may be used to provide increased BLE Advertisement transmit power with an operating range of 100 m+ if a Computing Device is limited to Class 2 or Class 3 BLE transmit power. A Computing Device, which may be custom designed, may also have built-in Class 1 BLE transmit power and may be used in an embedded application, permanently or semi-permanently installed at a location, with a display and with or without presenter interaction, or without a display or presenter interaction, managed remotely through a dashboard on the Remote Server. Multiple embedded computing devices may be installed at a location to cover a large area or dead spots, each computing device remotely managed through a dashboard on the Remote Sever.

In some embodiments, a Computing Device may have a WiFi interface with the ability to act as a WiFi wireless access point, and if allowed by the operating system on the Computing Device, the Second Package Of Data may be transmitted in the Service Set Identifier (SSID) of a WiFi beacon frame, as a Share App WiFi Frame, received by Mobile Devices through a WiFi interface. The SSID may be up to 32-bytes in length. Because the SSID is used as the network name of an access point, the network name of the Computing Device WiFi wireless access point will change while the Share App WiFi Frames are being transmitted and may be changed back to the original access point name when the transmissions have ceased. While transmitting Share App WiFi Frames, the Computing Device may not be able accept WiFi connection requests. The Computing Device's WiFi connection may be lost while the Share App WiFi Frames are being transmitted and reconnected when the transmissions have ceased. While transmitting ad hoc Share App WiFi Frames, the Computing Device may not accept WiFi connection requests.

The Basic Service Set Identifier (BSSID) or MAC Address of the WiFi wireless access point on the Computing Device may be randomized or set to the wildcard value to reduce the threat of tracking a Computing Device. The BSSID may also be set to a value with one or more 24-bit Organization Unique Identifiers (OUIs) assigned for the Share APP, effectively forming an Application ID, and the remaining 24-bits used for part or all of the Second Package of Data. In some embodiments, a Computing Device may have a WiFi interface with the ability to form or join an ad hoc WiFi network, and if allowed by the operating system on the Computing Device, the Second Package Of Data may be transmitted in the 6-byte BSSID of WiFi beacon frames with To DS and From DS both set to zero, which allows the BSSID to be set to a random value. In some embodiments, the Second Package Of Data may be transmitted by the Computing Device in the SSID or BSSID or in both the SSID and BSSID of a WiFi Beacon frame or a WiFi probe request, as a Share App WiFi Frame.

The Computing Device may scan for unused WiFi channels and transmit Share App WiFi Frames on an unused channel. Mobile Devices may scan for unused channels and only scan for Share App WiFi Frames on unused channels or channels with no traffic other than Share App WiFi Frames, and check received SSIDs and BSSIDs for any combination of an Application ID, Unique ID or Message ID. If there are no unused WiFi channels, a random channel may be selected by the Computing Device and Mobile Devices may be required to scan all channels. A Share App option to only scan for Share App WiFi Frames when the Share App is in the foreground may be used to reduce battery drain. The number of channels to scan may be reduced by using only non-overlapping channels, such as channels 1, 6, 11 and 14 (if available) on the 2.4 GHz band. In some embodiments, the Share App on a Mobile Device may transmit WiFi probe requests on each available WiFi channel with the BSSID and SSID set to the wildcard values and check WiFi probe responses for any combination of an Application ID, Unique ID or Message ID in any combination of an SSID or BSSID, extract the remaining elements of the Second Package Of Data from the SSID or BSSID, and query the Remote Server with a Unique ID and any combination of a Message ID or an Organization ID for a notification.

Using a Share App WiFi Frame instead of a Share App BLE Advertisement may provide more operating range, up to 50 m+, if Bluetooth Class 1 transmit power is not available on a Computing Device. The Share App on a Computing Device may automatically choose Share App WiFi Frames vs. Share App BLE Advertisements depending on a range setting made by the user of the Computing Device and the WiFi/BLE interface and operating system capabilities of the Computing Device, with the Share App on Mobile Devices scanning for both Share App WiFi Frames and Share App BLE Advertisements. If allowed by the WiFi interface and operating system, the output power of the WiFi interface may be varied to provide a custom operating range. Like retransmissions of Share App BLE Advertisements, retransmissions of Share App WiFi Frames by Mobile Devices may be used to reach additional Mobile Devices to extend the WiFi operating range of a Computing Device.

Part or all of the functionality of a Computing Device and the Share App may be integrated into a television, set-top box, media player, monitor, digital sign, kiosk, wireless access point, digital camera, projector or any similar device. Part or all of the functionality of the Share App may be integrated into a third-party application or into an operating system running on a Computing Device. Part or all of the functionality of the Share App may be integrated into a third-party application or into an operating system running on a Mobile Device, and in some embodiments the application or operating system may handle notifications, instructions or data from the Remote Server automatically, without confirmation by a Mobile Device user.

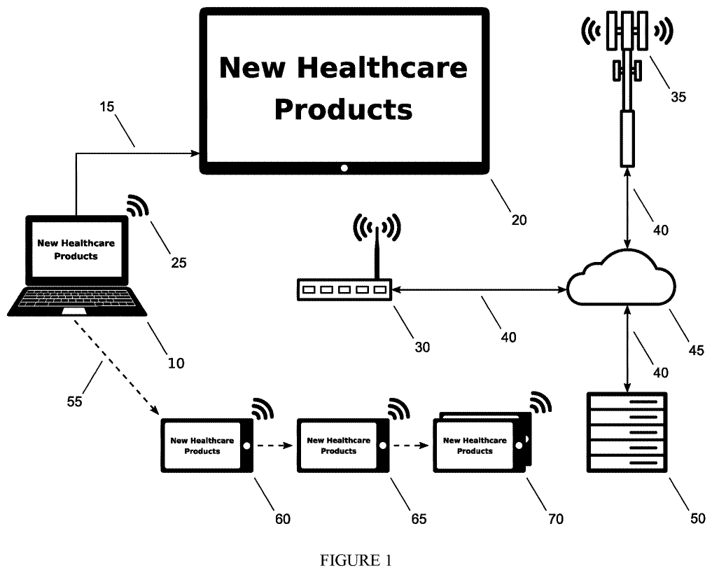

Referring to FIG. 1, an embodiment of the present disclosure is shown. A Computing Device such as a laptop (10) may connect, through an HDMI/DisplayPort or similar cable (15), or wirelessly through WiFi-Direct or equivalent open wireless standard or proprietary wireless standard, to a television, monitor or projector (20) to display a presentation to an audience. A presenter may use an application on the laptop (10), the Share App, to send a presentation file and metadata wirelessly (25) through a WiFi router (30) or a cellular data connection such as 3G/4G/LTE/5G (35), which are connected (40) through the Internet/Cloud (45) to a Remote Server (50), which authenticates the presenter and generates a preview of the file. The Share App on the laptop (10) may then transmit Share App BLE Advertisements (55) with an Application ID, a Message ID, a Unique ID and flag to retransmit the Share App BLE Advertisements to Mobile Devices in the audience. A first Mobile Device, a smartphone shown in landscape orientation (60) receives a Share App BLE Advertisement and the Share App on the Mobile Device (60), extracts the Application ID and confirms that the BLE Advertisement is for the Share App and checks that the Message ID has not already been received. The Share App on the first Mobile Device (60), may then send a query with the Unique ID and Message ID through a WiFi router (30) or cellular data connection (35) and in turn through the Internet/Cloud (45) to the Remote Server (50) to download and display a notification with the preview of the presentation file to the user of the first Mobile Device, and upon user selection or confirmation of the notification, may download the presentation file from the Remote Server (50) through the Internet/Cloud (45) and in turn through a WiFi router (30) or cellular data connection (35) and display the presentation file to the user. The first Mobile Device (60) may retransmit the Share App BLE Advertisement received from the Computing Device. A second Mobile Device (65) which may not be in the BLE range of the laptop (10) may receive a retransmitted Share App BLE Advertisement. The Share App on the second Mobile Device (65), may query the Remote Server (50) for the notification and upon user selection or confirmation of the notification, download and display the presentation file to the user. The second Mobile Device (65) may then retransmit the Share App BLE Advertisement to additional Mobile Devices (70).

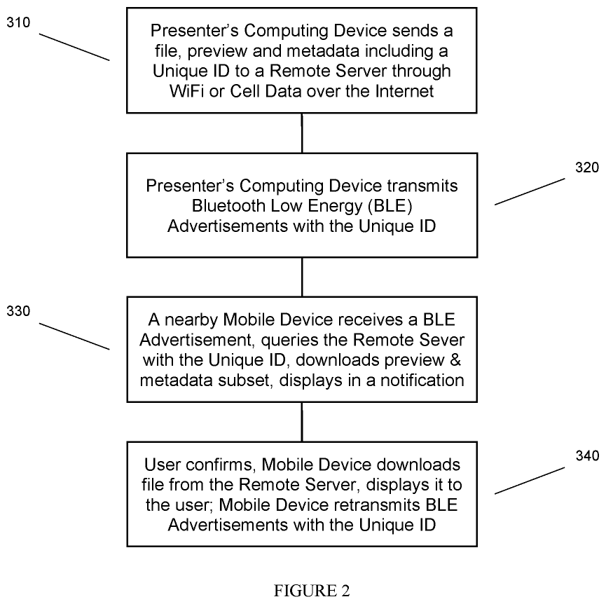

Referring to FIG. 2, there is provided a method for sending a file along with a preview and metadata, including a Unique ID from a presenter's Computing Device to a Remote Server, transmitting a Share App BLE Advertisement with the Unique ID, receiving the Share App BLE Advertisement on a Mobile Device, downloading and displaying a preview of the file and a subset of the metadata from the Remote Server in a notification on the Mobile Device, waiting for a user selection or confirmation of the notification, downloading the file from the Remote Server, displaying the file on the Mobile Device, and retransmitting the Share App BLE Advertisement. At box 310, a presenter uses the Share App running on a Computing Device to send a file, along with a preview file and metadata including a Unique ID, to a Remote Server through an Internet/network connection such as WiFi or a Cellular data connection. At Box 320, the Share App on the Computing Device transmits Share App BLE Advertisements with the Unique ID, which may be received by nearby Mobile Devices. At box 330, the Share App running on a nearby Mobile Device receives a Share App BLE Advertisement and queries the Remote Server with the Unique ID to download the preview file and a subset of the metadata, which is displayed to the user of the Mobile Device in a notification. At box 340, upon user selection or confirmation of the notification, the Share App on the Mobile Device downloads the file from the Remote Server, displays it to the user, and retransmits Share App BLE Advertisements with the Unique ID which may be received by nearby Mobile Devices.

In some embodiments, a system for sharing files, selected/highlighted sections or links in an ad hoc setting is provided. The system may include a computing device, operated by a computing device user, the computing device comprising a computer processor, computer readable memory, one or more user input devices, such as but not limited to a keyboard, discrete buttons, mouse or touchscreen, a Bluetooth Low Energy interface, wired or wireless Internet/network interfaces, such as but not limited to Ethernet, WiFi, and cellular networks 3G/4G/LTE/5G, and a geolocation interface, wherein the computing device is communicatively coupled to one or more displays, which may be incorporated into the computing device, and wherein the computer processor is communicatively coupled to the computer readable memory, the input devices, the Bluetooth Low Energy interface and the Internet/network interfaces, and is capable of running computer programs, applications, applets, apps, or scripts.

The system may include a computing device application stored in the computer readable memory coupled to the computing device and executable by the computer processor in the computing device. The computing device application may include a first computing device routine for allowing the selection or specification of a first package of data by the computing device user and sending the first package of data to a remote server through an Internet/network interface, as a single package or as individual elements in any order. In some embodiments, the first package of data comprises a file, selected/highlighted section or link, optionally with any combination of a graphical or text preview file which may be generated by the first computing device routine, a description, an icon, a logo, an organization, company or group name, a content title, or content text, as well as the computing device user's metadata comprising any combination of the user profile, username, alias, password, access level to features, unique identifier, device identifier, geolocation, user preferences, and message identifier. The selected/highlighted section may be converted to a file of any suitable format by the first computing device routine before it is sent to the remote server. The first package of data, once all elements have been selected or generated, may be stored in the computer readable memory of the computing device. The first computing device routine may allow the computing device user to select a first package of data from a list of previously stored first packages of data to be resent to the remote server with any necessary or required updates selected by the computing device user or automatically generated by the first computing device routine.

The remote server may be comprised of a computer processor and computer readable memory, and is capable of running computer programs, applications, applets, apps, or scripts to provide computing, data and data storage services and may provide software license registration services to other computers through Internet/network connections or interfaces, including generating a graphical or text preview of a file, selected/highlighted section or link if a preview was not generated by first computing device routine and included in the first package of data, and the uploading, security threat scanning and downloading of the first package of data and any individual elements in the first package of data sent by the computing device to the remote server including files, selected/highlighted sections and links, and confirming to the computing device application the file, selected/highlighted section or link may be shared. The remote server may be a virtual machine running on a cloud/utility computing service, accessed through Application Programming Interfaces (APIs), Function as a Server (FaaS) or similar platforms. The remote server may be managed by a remote server administrator. The remote server may store the first package of data in its computer readable memory and may allow the computing device user to select a first package of data from a list of stored first packages of data through the first computing device routine or a dashboard on the remote server.

The computing device application may include a second computing device routine for transmitting a second package of data in a Bluetooth Low Energy advertisement through the Bluetooth Low Energy interface for a time duration set by the user of the computing device or by the computing device application. The second package of data may be included in the Bluetooth Low Energy advertisement's data payload and may be comprised of a unique identifier and any combination of optional elements comprised of an application identifier, a message identifier, an organization identifier, flags, data, variables, values or commands based on the computing device user's preferences and the second computing device routine's implementation. Any combination of an application identifier, a message identifier, an organization identifier, flags, data, variables, values or commands may also be sent as part of the first package of data to the remote server by the first computing device routine. In some embodiments, the second package of data in the Bluetooth Low Energy advertisement may be comprised of a message identifier instead of a unique identifier, and any combination of a unique identifier, an application identifier, an organization identifier, flags, data, variables, values or commands, where the message identifier may be generated by the remote server when the first package of data is sent to the remote server and downloaded by the first computing device routine.

The system may include one or more mobile devices, each operated by a mobile device user, a mobile device comprising a computer processor, computer readable memory, a display and in some embodiments the ability to drive an external display, one or more user input devices such as but not limited to a keyboard, discrete buttons, mouse or touchscreen, a Bluetooth Low Energy interface, wired or wireless Internet/network interfaces such as but not limited to Ethernet, WiFi, 3G/4G/LTE/5G, a geolocation interface, is designed to be carried by a person, wherein the computer processor is communicatively coupled to the computer readable memory, the display, the input devices, the Bluetooth Low Energy interface, and the Internet/network interfaces, and is capable of running computer programs, applications, applets, apps, or scripts.

The system may include a mobile device application stored in the computer readable memory coupled to a mobile device, executable by the computer processor in the mobile device. The mobile device application may include a first mobile device routine for receiving the Bluetooth Low Energy advertisement sent by the computing device through the Bluetooth Low Energy interface and identifying the Bluetooth Low Energy advertisement through the application identifier if it is present. The first mobile device routine may also extract the unique identifier, and if present, extract any combination of the message identifier, the organization identifier, flags, data, variables, values or commands from the Bluetooth Low Energy advertisement. In some embodiments, where the Bluetooth Low Energy advertisement uses a message identifier instead of a unique identifier, the first mobile device routine may extract the message identifier from the Bluetooth Low Energy advertisement, and if present, extract any combination of a unique identifier, an organization identifier, flags, data, variables, values or commands.

The mobile device application may include a second mobile device routine for sending a query to the remote server with the unique identifier, and if present the message identifier or the organization identifier to download remote server data from the remote server through an Internet/network interface. In some embodiments, the second mobile device routine may query the remote sever with the message identifier and any combination of the unique identifier or the organization identifier if the Bluetooth Low Energy advertisement uses a message identifier instead of a unique identifier. In some embodiments, the remote server data may be comprised of any combination of a preview, a filename, a description, a link, an icon, a logo, file size, an organization, company or group name, a username, an alias, a geolocation, a content title, content text, mobile device metadata, a file, a selected/highlighted section as well as any combination of the application identifier, the message identifier, the organization identifier, flags, data, variables, values or commands if they were not present in the Bluetooth Low Energy advertisement and were sent to the remote server by the first computing device routine. The second mobile device routine may also display any combination of the preview, filename, link, icon, logo, file size, organization, company or group name, username, alias, geolocation, time, content title, or content text to the user of the mobile device in a notification or send the notification to the mobile device operating system, alert the user with any combination of sound, vibration or display of an icon in the status or notification area, drawer, bar or screen on the display of the mobile device. Upon user selection or confirmation with a click, tap or swipe on the notification, the second mobile device routine or the mobile device operating system may download the file, selected/highlighted section or link from the remote server through an Internet/network interface if a file, selected/highlighted section or link was not downloaded with the remote server data and display the file, selected/highlighted section or link to the user in an appropriate application on the mobile device. In some embodiments, the second mobile device routine may store the downloaded file, selected/highlighted section or link in the computer readable memory of the mobile device. The mobile device user may sync, copy or transfer any of the stored files, selected/highlighted sections or links to another computer, such as a laptop or desktop computer, or to cloud storage, using a wired or wireless link.

The mobile device application may include a third mobile computing device routine for retransmitting the Bluetooth Low Energy advertisement received from the computing device through the Bluetooth Low Energy interface, the data payload of the Bluetooth Low Energy advertisement comprised of a unique identifier and any combination of the application identifier, the message identifier, the organization identifier, flags, data, variables, values or commands, or comprised of the message identifier instead of the unique identifier and any combination of the unique identifier, the application identifier, the organization identifier, flags, data, variables, values or commands, until the completion of a time duration set in the mobile device application, a time duration set by the remote server, a time duration set by a value in the Bluetooth Low Energy advertisement or a pre-set number of hops from the sending computing device to the last receiving mobile device.

Additional wireless standards which use beacon-type frames or advertisements may be used. In some embodiments, the second package of data may be transmitted in any combination of the Service Set Identifier (SSID) or the Basic Service Set Identifier (BSSID) of a WiFi Beacon frame, probe request or probe response by the second computing device routine through a WiFi interface. A WiFi Beacon frame, probe request or probe response may be received by the first mobile device routine which may find any combination of an application identifier, unique identifier or message identifier in any combination an SSID or BSSID and extract any combination of the remaining elements of the second package of data. The second mobile device routine may query the remote server with a unique identifier and any combination of a message identifier or an organization identifier for a notification, and the second package of data may be retransmitted in any combination of the SSID or the BSSID of a WiFi Beacon frame, probe request or probe response by the third mobile device routine.

In some embodiments, a method for sharing files, selected/highlighted sections or links in an ad hoc setting is provided. The method may include sending, after selection or specification and by command of a computing device user, a first package of data from a computing device to a remote server through an Internet/network interface, as a single package or as individual elements in any order. In some embodiments, the first package of data comprises a file, selected/highlighted section or link, optionally with any combination of a graphical or text preview file which may be generated on the computing device, a description, an icon, a logo, an organization, company or group name, a content title, or content text, as well as the computing device user's metadata comprising any combination of the user profile, a username, an alias, a password, access level to features, a unique identifier, a device identifier, geolocation, user preferences and a message identifier. The method may further include generating a preview file on the remote server if a preview file was not included in the first package of data and the remote server scanning the first package of data for security threats before confirming that the file, selected/highlighted section or link may be shared, and may further include converting the selected/highlighted section to a file of any suitable format by the computing device before being sent to the remote server.

The method may further include transmitting, by a computing device, a second package of data in a Bluetooth Low Energy advertisement for a time duration set by the computing device user or by the computing device. In some embodiments, the second package of data may be included in the Bluetooth Low Energy advertisement's data payload and may be comprised of a unique identifier and any combination of an application identifier, a message identifier, an organization identifier, flags, data, variables, values or commands. In some embodiments, the second package of data in the Bluetooth Low Energy advertisement may be comprised of a message identifier instead of a unique identifier, and any combination of a unique identifier, an application identifier, an organization identifier, flags, data, variables, values or commands, where the message identifier may be generated by the remote server when the first package of data is sent to the remote server, and the message identifier downloaded by the computing device and included in the second package of data.

The method may further include receiving, by a mobile device, the Bluetooth Low Energy advertisement with the unique identifier and any combination of the application identifier, the message identifier, the organization identifier, flags, data, variables, values or commands. In some embodiments, the method may include receiving, by a mobile device, the Bluetooth Low Energy advertisement with the message identifier instead of the unique identifier and any combination of the unique identifier, the application identifier, the organization identifier, flags, data, variables, values or commands. Any combination of the application identifier, message identifier, organization identifier, flags, data, variables, values or commands may also be included in the first package of data sent by the computing device to the remote server. The method may include identifying the Bluetooth Low Energy advertisement through the application identifier if an application identifier is present in the Bluetooth Low Energy advertisement.

The method may also include sending, from the mobile device, a query to the remote server with a unique identifier, and any combination of a message identifier or an organization identifier, or in some embodiments a query with a message identifier instead of a unique identifier and any combination of a unique identifier or an organization identifier, to download remote server data comprised of any combination of a preview, a filename, a description, a link, an icon, a logo, file size, an organization, company or group name, a username, an alias, a geolocation, a content title, content text, mobile device metadata, a file, a selected/highlighted section as well as any combination of the application identifier, the message identifier, the organization identifier, flags, data, variables, values or commands if they are not present in the Bluetooth Low Energy advertisement, from the remote server through an Internet/network interface, displaying any combination of the preview, filename, description, link, icon, logo, file size, organization, company or group name, username, alias, geolocation, content title, or content text to the user of the mobile device in a notification or sending the notification to the mobile device operating system, alerting the user with any combination of sound, vibration or an icon in the status or notification area, drawer, bar or screen of the mobile device, waiting for user selection or confirmation with a click, tap or swipe on the notification, downloading the file or selected/highlighted section from the remote server through an Internet/network interface if a file or selected/highlighted section was not downloaded with the remote server data, and displaying the file, selected/highlighted section or link to the user in an appropriate application. In some embodiments, the method may include storing the file, selected/highlighted section or link in the mobile device's computer readable memory.

The method may also include retransmitting, by the mobile device, the Bluetooth Low Energy advertisement received from the computing device, the data payload of the Bluetooth Low Energy advertisement comprised of the unique identifier and any combination of the application identifier, message identifier, organization identifier, flags, data, variables, values or commands, or comprised of the message identifier instead of the unique identifier and any combination of the unique identifier, application identifier, organization identifier, flags, data, variables, values or commands, until the completion of a time duration set in the mobile device, a time duration set by the remote server, a time duration set by a value in the Bluetooth Low Energy advertisement or a pre-set number of hops from the sending computing device to the last receiving mobile device.

The method may also include allowing the user of a computing device to send a notification for a file, selected/highlighted section or link to mobile devices that are registered with an organization or subset of an organization through the remote server, with or without the remote server receiving queries from the mobile devices resulting from the reception of Bluetooth Low Energy advertisements sent by the presenter's computing device.

The method may also include allowing a remote server administrator to send a notification for a file, selected/highlighted or link to computing or mobile devices globally, or through the geolocation of the computing or mobile device, a notification for a file, selected/highlighted section or link selected by geographic region, country, state/province, city, district, postal/zip code or region defined by a latitude/longitude graticule.

The method may also include using additional wireless standards which use beacon-type frames or advertisements. In some embodiments, the method may include transmitting, by a computing device, the second package of data in any combination of the Service Set Identifier (SSID) or the Basic Service Set Identifier (BSSID) of a WiFi beacon frame, probe request or probe response. The method may further include receiving, by a mobile device, a WiFi beacon frame, probe request or probe response and finding any combination of an application identifier, unique identifier or message identifier in any combination of an SSID or BSSID, extracting the remaining elements from the second package of data and sending a query to the remote server with a unique identifier and any combination of a message identifier or an organization identifier for a notification. The method may also include retransmitting, by a mobile device, the second package of data in any combination of the SSID or the BSSID of a WiFi beacon frame, probe request or probe response.

The method may be implemented in a computer program product, which may be comprised of one or more computer programs running on computing devices, mobile devices and the remote server, for sharing files, selected/highlighted sections or links in an ad hoc setting. The method may also be incorporated into third-party applications or into operating systems running on computing devices, mobile devices and the remote server.

The terminology used herein is for the purpose of describing particular embodiments only and is not intended to be limiting. Accordingly, as used herein, the singular forms “a”, “an” and “the” are intended to include the plural forms as well, unless the context clearly indicates otherwise.

It is contemplated that any part of any aspect or embodiment discussed in this specification may be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A system for sharing files, selected/highlighted sections or links in an ad hoc setting, the system comprising:
(a) a computing device, operated by a computing device user, the computing device comprising a computer processor, computer readable memory, one or more displays, one or more user input devices, a Bluetooth Low Energy interface, wired or wireless Internet/network interfaces, a geolocation interface, and is capable of running computer programs, applications, applets, apps, or scripts;
(b) one or more mobile devices, each operated by a mobile device user, each of the one or more mobile devices comprising a computer processor, computer readable memory, a display, one or more user input devices, a Bluetooth Low Energy interface, wired or wireless Internet/network interfaces, a geolocation interface, is designed to be carried by a person, and is capable of running computer programs, applications, applets, apps, or scripts;
(c) a remote server, the remote server comprising a computer processor and computer readable memory, or a virtual machine running on a cloud/utility computing service and is capable of running computer programs, applications, applets, apps, or scripts, to provide computing, software license registration, data and data storage services to other computers through Internet/network interfaces, and uploading, security threat scanning, and downloading of a first package of data and any individual elements in the first package of data sent by the computing device to the remote server including files, selected/highlighted sections and links;
(d) a computing device application stored in a computer readable memory coupled to the computing device, executable by the processor in the computing device, the application comprising:
(i) a first computing device routine for allowing the selection or specification of the first package of data by the computing device user and sending the first package of data comprising a file, selected/highlighted section or link, with any combination of optional elements comprised of a graphical or text preview file, a description, an icon, a logo, an organization, company or group name, a content title, or content text, as well as with the computing device user's metadata and optionally an application identifier, a message identifier, an organization identifier, flags, data, variables, values or commands to the remote server through an Internet/network interface on the computing device as a single package or as individual elements in any order;
(ii) a second computing device routine for transmitting a second package of data in a Bluetooth Low Energy advertisement through the Bluetooth Low Energy interface, the second package of data included in the Bluetooth Low Energy data payload and comprised of a unique identifier and any combination of optional elements comprised of the application identifier, the message identifier, the organization identifier, the flags, the data, the variables, the values or the commands based on the computing device user's preferences and second computing device routine's implementation, wherein transmission occurs for a time duration set by the user of the computing device or by the computing device application;
(e) a mobile device application stored in a computer readable memory coupled to the mobile device, executable by the processor in the mobile device, the application comprising:
(i) a first mobile device routine for receiving the Bluetooth Low Energy advertisement sent by the computing device through the Bluetooth Low Energy interface, identifying the Bluetooth Low Energy advertisement through the application identifier if it is present, and extracting the unique identifier and if present, extracting the message identifier, the organization identifier, the flags, the data, the variables, the values or the commands from the Bluetooth Low Energy advertisement;
(ii) a second mobile device routine for sending a query to the remote server with the unique identifier and if present the message identifier and the organization identifier to download remote server data comprised of at least one of a preview, a filename, a description, a link, an icon, a logo, file size, an organization, company or group name, a username, an alias, a geolocation, a content title, content text, mobile device metadata, a file, a selected/highlighted section as well as any combination of the application identifier, the message identifier, the organization identifier, the flags, the data, the variables, the values or the commands if they were not present in the Bluetooth Low Energy advertisement and were sent to the remote server by the first computing device routine, from the remote server through an Internet/network interface, for displaying at least one of the preview, filename, link, icon, logo, file size, organization, company or group name, username, alias, geolocation, time, content title, or content text to the user of the mobile device in a notification, alerting the user with at least one of a sound, vibration or display of an icon on the display of the mobile device, for downloading the file, selected/highlighted section or link from the remote server upon selection or confirmation of the notification by the mobile device user through an Internet/network interface if the file, selected highlighted section or link was not downloaded with the remote server data, and for displaying the file, selected/highlighted section or link on the mobile device or storing the file, selected/highlighted section or link in the computer readable memory of the mobile device;
(iii) a third mobile computing device routine for retransmitting the Bluetooth Low Energy advertisement received from the computing device through the Bluetooth Low Energy interface, the data payload of the Bluetooth Low Energy advertisement comprising the unique identifier and any combination of optional elements comprised of the application identifier, the message identifier, the organization identifier, the flags, the data, the variables, the values or the commands, wherein retransmission continues until the completion of a time duration set in the mobile device application, a time duration set by the remote server, a time duration set by a value in the Bluetooth Low Energy advertisement or a pre-set number of hops from the sending computing device to the last receiving mobile device.

2. The system of claim 1, wherein the second package of data transmitted by the second computing device routine in the data payload of the Bluetooth Low Energy advertisement is comprised of the message identifier and any combination of optional elements comprised of the unique identifier, the application identifier, the organization identifier, the flags, the data, the variables, the values or the commands, the message identifier generated by the remote server when the first package of data is sent to the remote server and downloaded by the first computing device routine and included in the second package of data, with the query to the remote server by the second mobile device routine using the message identifier and any combination of optional elements comprised of the unique identifier and the organization identifier, and retransmitting, by the third mobile device routine, the Bluetooth Low Energy advertisement with the data payload comprised of the message identifier and any combination of optional elements comprised of the unique identifier, the application identifier, the organization identifier, the flags, the data, the variables, the values or the commands.

3. The system of any claims 1 and 2, wherein the selected/highlighted section is converted to a file of any suitable format by the first computing device routine before it is sent to the remote server, the graphical or text preview of the file, selected/highlighted section or link is generated by the first computing device routine or by the remote server, the remote server scans the first package of data for security threats and confirms to the computing device application that the file, selected/highlighted section or link is ready to be shared, and wherein all uploads to, downloads from, and communications with the remote server by the computing device or the mobile devices are encrypted.

4. The system of any claims 1 to 3, wherein the user of the computing device sends the notification for the file, selected/highlighted section or link to mobile devices that are registered with an organization or a subset of the organization through the remote server, with or without the remote server receiving queries from the mobile devices resulting from the reception of Bluetooth Low Energy advertisements sent by the computing device.

5. The system of any claims 1 to 4, wherein a remote server administrator sends the notification for the file, selected/highlighted section or link to the computing or mobile devices globally, or through the geolocation of the computing or mobile devices, the notification for the file, selected/highlighted section or link for a geographic region, country, state/province, city, district, postal/zip code or a region defined by a latitude/longitude graticule, or the notification for the file, selected/highlighted section or link selected for a geographic region, country, state/province, city, district, postal/zip code or a region defined by a latitude/longitude graticule.

6. The system of any claims 1 to 5, wherein the user of the computing device sends the notification for the file, selected/highlighted section or link to the mobile devices within a specified radius of the computing device, based on the geolocation of the computing device and the tracked geolocations of the mobile devices.

7. The system of any claims 1 to 6, wherein the notifications are displayed in the status or notification area, drawer, bar or screen of the mobile device in the order they are received, or are displayed in the mobile device application with the notifications arranged in the order they are received, alphabetically, by organization, company or group names, or as multiple lists arranged by categories or keywords parsed from descriptions, filenames, usernames, aliases, content titles, or content texts, or are displayed in both the status or notification area, drawer, bar or screen of the mobile device and in the mobile device application, and wherein the notifications displayed in the mobile device application persist when the notifications are dismissed or deleted from the status or notification area, drawer, bar or screen of the mobile device.

8. The system of any claims 1 to 7, wherein the second computing device routine transmits the second package of data in the Bluetooth Low Energy advertisements in multiple formats sequentially on each of the Bluetooth Low Energy advertisement channels so that mobile devices configured to receive only one format of a Bluetooth Low Energy advertisement will receive a Bluetooth Low Energy advertisement with the second package of data, or transmits the Bluetooth Low Energy advertisements in a single format on each of the Bluetooth Low Energy advertisement channels and mobile devices are configured to receive all Bluetooth Low Energy advertisement formats or the single transmitted Bluetooth Low Energy advertisement format.

9. The system of any claims 1 to 8, wherein the computing device user's preferences comprises flags and/or settings for the time duration for transmitting the Bluetooth Low Energy advertisements; the time duration a file, selected/highlighted section, or link is to remain active on the remote server; allow viewing only of a file, selected/highlighted section or link by mobile device users; a request to mobile devices to retransmit Bluetooth Low Energy advertisements received from the computing device, the time duration of the retransmissions, the maximum number of hops, and more frequent scanning of Bluetooth Low Energy advertisements.

10. The system of any claims 1 to 9, wherein the user of the computing device selects multiple files, selected/highlighted sections, or links to send to mobile devices.

11. The system of any claims 1 to 10, wherein the user of the computing device defines a security code in the computing device application which is sent with the computing device user's metadata to the remote server, and which is entered by the user of each of the one or more mobile devices before the remote server allows the download of the file, preview file, selected/highlighted section, description or link by each of the one or more mobile devices.

12. The system of any claims 1 to 11, wherein unique identifiers are globally unique, and wherein the unique identifier assigned to the user of the computing device or to the computing device is assigned by the computing device application or by the remote server, and further wherein the unique identifier assigned to each user of the one or more mobile devices or to each of the one or more mobile devices is assigned by the mobile device application or by the remote server.

13. The system of any claims 1 to 12, wherein device identifiers are globally unique and are assigned to the computing device or the mobile devices by the remote server.

14. The system of any claims 1 to 13, wherein the first computing device routine allows the computing device user to select the first package of data from a list of first packages of data stored in the computer readable memory of computing device or in the computer readable memory of remote server, and wherein the remote server allows the selection of a first package of data through a dashboard.

15. The system of any claims 1 to 14, wherein the description includes instructions or commands to the operating system of the mobile device to launch an application or service or update a list with data from the file, context text or the description, the data including social media symbols, labels or tags, email addresses, phone numbers, contacts, meetings, appointments and electronic business cards and wherein a subsequently received description provides an update to the application, service or list.

16. The system of any claims 1 to 15 wherein the second package of data transmitted in the Bluetooth Low Energy advertisement further comprises commands for a file, selected/highlighted section, or link previously sent.

17. The system of any claims 1 to 16, wherein registration with an organization is granted to computing devices, mobile devices, users of computing devices and users of mobile devices, and wherein a computing device registered to an organization is commanded by the remote server to transmit a second package of data in a Bluetooth Low Energy advertisement for a file or link stored in the computing device or on the remote server without any intervention or commands by the user of the computing device.

18. The system of any claims 1 to 17 wherein the mobile device application stores received Bluetooth Low Energy advertisements which contain a second package of data, or stores the second packages of data extracted from the data payloads of the Bluetooth Low Energy advertisements, in the computer readable memory of a mobile device if an Internet/network interface is not available at the time of Bluetooth Low Energy advertisement reception, and wherein the mobile device application queries the remote server with elements extracted from the stored Bluetooth Low Energy advertisements or the stored second packages of data when an Internet/network interface becomes available, downloads and displays the associated notifications if the file, selected/highlighted section or link associated with each Bluetooth Low Energy advertisement has not expired on the remote server and deletes the stored Bluetooth Low Energy advertisements or the stored second packages of data.

19. The system of any claims 1 to 18 wherein Bluetooth Low Energy advertisements which contain a second package of data or notifications from the remote server are ignored or filtered by the mobile device application according to preferences or options set by the mobile device user.

20. The system of any claims 1 to 19 wherein the computing device is used to send files, selected/highlighted sections or links to the mobile devices for location-based proximity marketing or proximity-based ad hoc messaging.

21. The system of any claims 1 to 20 wherein the computing device or the remote server is used to send files, descriptions or links associated with broadcast, cable or streaming programs to the mobile devices.

22. The system of any claims 1 to 21 wherein received notifications and notification follow-throughs, optionally combined with search history and user preferences, are tracked by the remote server to provide statistics to computing device users, proximity marketers and inline advertisers, and wherein the statistics are used to provide customized or updated files, selected/highlighted sections, links or inline advertisements to optimize follow-throughs.

23. The system of any claims 1 to 22 wherein the computing device application and mobile device application are combined into a single device application, and further wherein the computing device acts as one of the mobile devices when not being used as the computing device, and wherein one of the mobile devices acts as the computing device when commanded to by the user of the mobile device.

24. The system of any claims 1 to 23 wherein the Bluetooth Low Energy advertisement contains only the unique identifier, and the remote server confirms the application identity of the Bluetooth Low Energy advertisement upon query by the mobile devices with the unique identifier, and the remote server provides the message identifier, the organization identifier, the flags, the data, the variables, the values and the commands uploaded by the computing device to the mobile devices.

25. The system of any claims 1 to 24 wherein the operating range of Bluetooth Low Energy Advertisements is increased or decreased by increasing or decreasing the Bluetooth transmit power of a computing device or add-on hardware, or by increasing or decreasing a minimum Received Signal Strength Indicator value in the second package of data.

26. The system of any claims 1 to 25 wherein part or all of functionality of the computing device and computing device application are integrated into a television, set-top box, media player, monitor, digital sign, kiosk, wireless access point, digital camera, projector or any similar device or wherein the computing device is custom-designed and used in an embedded application.

27. The system of any claims 1 to 26 wherein part or all of functionality of the computing device application is integrated into a third-party application or an operating system running on the computing device, or wherein the computing device application is launched or used by a third-party application or a script, with or without launching the computing device application user interface.

28. The system of any claims 1 to 27 wherein part or all of functionality of the mobile device application is integrated into a third-party application or an operating system running on the mobile devices, or wherein the mobile device application is launched or used by a third-party application or a script, with or without launching the mobile device application user interface.

29. The system of claims 1 to 28 wherein the second package of data is transmitted in the Service Set Identifier (SSID) or the Basic Service Set Identifier (BSSID) or in both the SSID and the BSSID of a WiFi Beacon frame, probe request or probe response by the second computing device routine, received by the first mobile device routine, and retransmitted by the third mobile device routine.

30. A method for sharing files, selected/highlighted sections or links in an ad hoc setting, the method comprising:
(a) sending, after selection or specification and by command of a computing device user, a first package of data comprising a file, selected/highlighted section or link, with any combination of optional elements comprised of a graphical or text preview file, a description, an icon, a logo, an organization, company or group name, a content title, or content text, as well as the computing device user's metadata from a computing device to a remote server through an Internet/network interface, as a single package or as individual elements in any order;
(b) transmitting, by a computing device, a Bluetooth Low Energy advertisement, wherein the Bluetooth Low Energy advertisement comprises as its data payload a second package of data, the second package of data comprising a unique identifier, and any combination of optional elements comprised of an application identifier, a message identifier, an organization identifier, flags, data, variables, values or commands, for a time duration set by the computing device user or by the computing device;
(c) receiving, by a mobile device, the Bluetooth Low Energy advertisement and identifying the Bluetooth Low Energy advertisement through the application identifier if the application identifier is present in the Bluetooth Low Energy advertisement;
(d) sending, from the mobile device, a query to the remote server with the unique identifier and if present the message identifier or the organization identifier to download remote server data comprised of at least one of a preview, a filename, a description, a link, an icon, a logo, file size, an organization, company or group name, a username, an alias, a geolocation, a content title, content text, mobile device metadata, a file, a selected/highlighted section as well as any combination of the application identifier, the message identifier, the organization identifier, the flags, the data, the variables, the values or the commands if said combination is not present in the Bluetooth Low Energy advertisement, from the remote server through an Internet/network interface; and
(e) displaying at least one of the preview, filename, description, link, icon, logo, file size, organization, company or group name, username, alias, geolocation, content title, or content text to the user of the mobile device in a notification, alerting the user with at least one of a sound, vibration or an icon in the status or notification area, drawer, bar or screen of the mobile device, waiting for user selection or confirmation with a click, tap or swipe on the notification, downloading a file or selected/highlighted section from the remote server through an Internet/network interface if a file or selected/highlighted section was not downloaded with the remote server data, and displaying the file, selected/highlighted section or link to the user in an appropriate application or storing the file, selected/highlighted section or link in the mobile device's computer readable memory; and
(f) retransmitting, by the mobile device, the Bluetooth Low Energy advertisement, wherein retransmission continues until the completion a duration of time set in the mobile device, a time duration set by the remote server, a time duration set by a value in the Bluetooth Low Energy advertisement or a pre-set number of hops from the sending computing device to a last receiving mobile device.

31. The method of claim 30, wherein any combination of optional elements comprised of the application identifier, the message identifier, the organization identifier, the flags, the data, the variables, the values or the commands is included in the first package of data.

32. The method of any claims 30 to 31, wherein the second package of data transmitted by the computing device in the data payload of a Bluetooth Low Energy advertisement is comprised of the message identifier and any combination of optional elements comprised of the unique identifier, the application identifier, the organization identifier, the flags, the data, the variables, the values or the commands, the message identifier generated by the remote server when the first package of data is sent to the remote server and downloaded by the computing device and included in the second package of data, with the query to the remote server by the mobile device using the message identifier and if present the unique identifier and the organization identifier, and retransmitting, by the mobile device, the Bluetooth Low Energy advertisement with a data payload comprised of the message identifier and any combination of optional elements comprised of the unique identifier, the application identifier, the organization identifier, the flags, the data, the variables, the values or the commands.

33. The method of any claims 30 to 32, wherein the selected/highlighted section is converted to a file of any suitable format before being sent to the remote server, and further wherein the graphical or text preview of the file, selected/highlighted section or link is generated by the computing device or by the remote server, and wherein the remote server scans the first package of data for security threats before confirming that the file, selected/highlighted section or link is ready to be shared.

34. The method of any claims 30 to 33, wherein the user of the computing device sends a notification for a file, selected/highlighted section or link to mobile devices that are registered with an organization or subset of an organization through the remote server, with or without the remote server receiving queries from the mobile devices resulting from the reception of Bluetooth Low Energy advertisements sent by the computing device.

35. The method of any claims 30 to 34, wherein a remote server administrator sends a notification for a file, selected/highlighted section or link to computing or mobile devices globally, or through the geolocation of the computing or mobile device, a notification for a file, selected/highlighted section or link selected by geographic region, country, state/province, city, district, postal/zip code or region defined by a latitude/longitude graticule.

36. The method of any claims 30 to 35, wherein the second package of data is transmitted in the Service Set Identifier (SSID) or the Basic Service Set Identifier (BSSID) or in both the SSID and the BSSID of a WiFi Beacon frame, probe request or probe response by the computing device, received by the mobile device, and retransmitted by the mobile device.

37. The method of any claims 30 to 36, wherein the method is implemented in a computer program product comprised of one or more computer programs, or incorporated into third-party applications or into operating systems running on computing devices, mobile devices and the remote server, for sharing files, selected/highlighted sections or links in an ad hoc setting.

38. A system for sharing a first package of data on a computing device with one or more mobile devices through a remote server on an ad hoc basis, the system comprising:
(a) a computing device application stored in a computer readable memory coupled to the computing device, executable by a processor in the computing device, the computing device application comprising:
(i) a first computing device routine for allowing the selection or specification of the first package of data by the computing device user and sending, through a network interface of the computing device, the first package of data to the remote server;
(ii) a second computing device routine for transmitting a second package of data in a Bluetooth Low Energy advertisement data payload through a Bluetooth Low Energy interface, or in the Service Set Identifier (SSID) or in the Basic Server Service Set Identifier (BSSID) or in both the SSID and the BSSID of a WiFi Beacon frame, probe request or probe response through a WiFi interface, the second package of data comprising a unique identifier and any combination of optional elements comprised of an application identifier, a message identifier, an organization identifier, flags, data, variables, values or commands, or a message identifier and any combination of optional elements comprised of a an application identifier, a unique identifier, an organization identifier, flags, data, variables, values or commands based on the computing device user's preferences and second computing device routine's implementation, wherein transmissions are for a time duration set by the user of the computing device or by the computing device application;
(b) a mobile device application stored in a computer readable memory coupled to the mobile device, executable by a mobile device processor, the mobile device application comprising:
(i) a first mobile device routine for receiving the Bluetooth Low Energy advertisement or WiFi Beacon frame, probe request or probe response sent by the computing device through the Bluetooth Low Energy interface or the WiFi interface, identifying the Bluetooth Low Energy advertisement or WiFi Beacon frame, probe request or probe response through the application identifier if it is present, and extracting the unique identifier or the message identifier and any combination of the remaining optional elements in the second package of data from the Bluetooth Low Energy advertisement or WiFi Beacon frame, probe request or probe response;
(ii) a second mobile device routine for sending a query to the remote server with the unique identifier and if present in the second package of data the message identifier and the organization identifier or a query with the message identifier and if present in the second package of data the unique identifier and the organization identifier to download elements of the first package of data comprised of at least one of a preview, a filename, a description, a link, an icon, a logo, file size, an organization, company or group name, a username, an alias, a geolocation, a content title, content text, mobile device metadata, as well as any combination of optional elements comprised of the unique identifier, the application identifier, the message identifier, the organization identifier, the flags, the data, the variables, the values or the commands if they were not present in the Bluetooth Low Energy advertisement or WiFi Beacon frame, probe request or probe response and were sent to the remote server by the first computing device routine, from the remote server through an Internet/network interface, for displaying at least one of the preview, filename, link, icon, logo, file size, organization, company or group name, username, alias, geolocation, time, content title, or content text in a notification on the display of the mobile device, for downloading the file, selected/highlighted section or link contained in the first package of data from the remote server upon selection or confirmation of the notification by the mobile device user, and displaying the file, selected/highlighted section or link on the mobile device;
(iii) a third mobile computing device routine for retransmitting the Bluetooth Low Energy advertisement or the WiFi Beacon frame, probe request or probe response received from the computing device through the Bluetooth Low Energy interface or the WiFi interface, wherein the retransmitting continues until the completion of a time duration set in the mobile device application, a time duration set by the remote server, a time duration set by a value in the Bluetooth Low Energy advertisement or WiFi Beacon frame, probe request or probe response, or a pre-set number of hops from the sending computing device to a last receiving mobile device.
